(19) United States
(12) Patent Application Publication
(10) Pub. No.: US 2026/0298471 A1
(43) Pub. Date: Oct. 1, 2026

(54) TURBINE ENGINE INCLUDING A COMBUSTOR

(71) Applicant: General Electric Company, Evendale, OH (US)

(72) Inventors: Hiranya Nath, Bengaluru (IN); Clayton S. Cooper, Loveland, OH (US); Steven C. Vise, Loveland, OH (US); Michael A. Benjamin, Flagler Beach, FL (US); Richard W. Stickles, Loveland, OH (US); Pradeep Naik, Bengaluru (IN); Perumallu Vukanti, Bengaluru (IN); Ranganatha Narasimha Chiranthan, Bengaluru (IN); Karthikeyan Sampath, Bengaluru (IN); Arvind Bharathi, Bengaluru (IN); Nicholas R. Overman, Sharonville, OH (US)

(21) Appl. No.: 19/698,445

(22) Filed: Jun. 4, 2026

Related U.S. Application Data
(62) Division of application No. 18/326,669, filed on May 31, 2023.

(51) Int. Cl. F23R 3/34; F23R 3/42; F23R 3/50

(52) U.S. Cl. CPC F23R 3/34; F23R 3/346; F23R 3/42; F23R 3/50; F23R 2900/00015

(57) ABSTRACT

A combustor for a turbine engine includes a combustion chamber including an outer liner and an inner liner, an annular dome, and a trapped vortex cavity (TVC) downstream of the annular dome. A plurality of first mixing assemblies are disposed through the annular dome and include a pilot mixer and a first main mixer. The pilot mixer injects a pilot mixer fuel-air mixture axially into a first combustion zone, and the first main mixer injects a first main mixer fuel-air mixture radially into the first combustion zone. A plurality of second mixing assemblies are disposed at the TVC axially aft of the first mixing assemblies and include a second main mixer. The second main mixer injects a second main mixer fuel-air mixture into a second combustion zone defined by the TVC and axially aft of the first combustion zone. The TVC injects the combustion gases into the combustion chamber.

### CROSS REFERENCE TO RELATED APPLICATIONS

This application is a divisional of U.S. patent application Ser. No. 18/326,669 filed on May 31, 2023, the contents of which are hereby incorporated by reference in their entirety.

### TECHNICAL FIELD

The present disclosure relates generally to turbine engines including combustors.

### BACKGROUND

A turbine engine generally includes a fan and a core section arranged in flow communication with one another. A combustor is arranged in the core section to generate combustion gases for driving a turbine of the turbine engine.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic cross-sectional diagram of a turbine engine, taken along a longitudinal centerline axis of the turbine engine, according to the present disclosure.

FIG. 2 is a schematic cross-sectional diagram of a combustor for the turbine engine of FIG. 1, taken along a longitudinal centerline axis of the turbine engine, according to the present disclosure.

FIG. 3 is an enlarged, schematic cross-sectional view of a combustor, taken along a longitudinal centerline axis of the combustor, according to another embodiment.

FIG. 4 is a schematic top view of a single, discrete trapped vortex cavity (TVC) for the combustor of FIG. 2, according to the present disclosure.

FIG. 5 is a schematic front view of a combustor, according to another embodiment.

FIG. 6 is a schematic front view of a combustor, according to another embodiment.

FIG. 7 is a schematic front view of a combustor, according to another embodiment.

FIG. 8 is a schematic front view of a combustor, according to another embodiment.

FIG. 9 is a schematic front view of a combustor, according to another embodiment.

FIG. 10 is a schematic front view of a combustor, according to another embodiment.

FIG. 11 is an enlarged, schematic, cross-sectional view of a combustor, taken along a longitudinal centerline axis of the combustor, according to another embodiment.

FIG. 12 is an enlarged, schematic, cross-sectional view of a combustor, taken along a longitudinal centerline axis of the combustor, according to another embodiment.

FIG. 13 is an enlarged, schematic, cross-sectional view of a combustor, taken along a longitudinal centerline axis of the combustor, according to another embodiment.

FIG. 14 is a partial, schematic, cross-sectional view of a combustor for a turbine engine, taken along a longitudinal centerline axis of the turbine engine, according to another embodiment.

FIG. 15 is an enlarged schematic, cross-sectional view of the combustor of FIG. 14, taken at cross section 15-15 in FIG. 14, according to the present disclosure.

FIG. 16 is an enlarged schematic, cross-sectional view of a trapped vortex cavity (TVC) for a combustor for a turbine engine, taken at a lateral centerline axis of the TVC, according to another embodiment.

FIG. 17 is a schematic side view of a combustor, according to another embodiment.

FIG. 18 is a schematic side view of a portion of a combustor, according to another embodiment.

FIG. 19 is a partial, schematic, cross-sectional view of a combustor for a turbine engine, taken along a longitudinal centerline axis of the turbine engine, according to another embodiment.

FIG. 20 is an enlarged schematic, cross-sectional view of the combustor of FIG. 19, taken at cross section 20-20 in FIG. 19, according to the present disclosure.

FIG. 21 is an enlarged schematic, cross-sectional view of a trapped vortex cavity (TVC) for a combustor for a turbine engine, taken at a lateral centerline axis of the TVC, according to another embodiment.

FIG. 22 is a partial, schematic, cross-sectional view of a combustor for a turbine engine, taken along a longitudinal centerline axis of the turbine engine, according to another embodiment.

FIG. 23 is an enlarged schematic, cross-sectional view of the combustor of FIG. 19, taken at cross section 23-23 in FIG. 22, according to the present disclosure.

### DETAILED DESCRIPTION

Additional features, advantages, and embodiments of the present disclosure are set forth or apparent from a consideration of the following detailed description, drawings, and claims. Moreover, both the foregoing summary of the present disclosure and the following detailed description are exemplary and intended to provide further explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and the scope of the present disclosure.

As used herein, the terms “first,” “second,” and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and refer to the normal operational attitude of the turbine engine or vehicle. For example, with regard to a turbine engine, forward refers to a position closer to an engine inlet and aft refers to a position closer to an engine nozzle or exhaust.

As used herein, the terms “low,” “mid” (or “mid-level”), and “high,” or their respective comparative degrees (e.g., “lower” and “higher”, where applicable), when used with compressor, turbine, shaft, fan, or turbine engine components, each refers to relative pressures, relative speeds, relative temperatures, and/or relative power outputs within an engine unless otherwise specified. For example, a “low power” setting defines the engine configured to operate at a power output lower than a “high power” setting of the engine, and a “mid-level power” setting defines the engine configured to operate at a power output higher than a “low power” setting and lower than a “high power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine.

The various power levels of the turbine engine detailed herein are defined as a percentage of a sea level static (SLS) maximum engine rated thrust. Low power operation includes, for example, less than thirty percent (30%) of the SLS maximum engine rated thrust of the turbine engine. Mid-level power operation includes, for example, thirty percent (30%) to eighty-five (85%) of the SLS maximum engine rated thrust of the turbine engine. High power operation includes, for example, greater than eighty-five percent (85%) of the SLS maximum engine rated thrust of the turbine engine. The values of the thrust for each of the low power operation, the mid-level power operation, and the high power operation of the turbine engine are exemplary only, and other values of the thrust can be used to define the low power operation, the mid-level power operation, and the high power operation.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

Combustors for turbine engines, such as turbine engines for aircraft, ignite fuel and air mixtures to produce combustion gases, which in turn drive one or more turbines of the turbine engine, thereby rotating one or more loads (e.g., a fan, a propeller, etc.). Air pollution concerns have led to stricter combustion emissions standards. Such standards regulate the emission of nitrogen oxide (NOₓ), non-volatile particulate matter (nvPM), as well as other types of exhaust emissions, from the turbine engine. The nvPM includes, for example, soot, smoke, or the like. Generally, NOₓ is formed during the combustion process due to high flame temperatures in the combustor. Turbine engine design tradeoffs are necessary to meet requirements for noise, emissions, fuel burn, cost, weight, and performance. As temperatures in the combustor increase, NOₓ generation increases due to the higher temperatures. In turbine engine design, balancing a reduction in NOₓ emissions, nvPM emissions, CO₂, and noise, while achieving improved engine performance, is difficult. For example, combustor design changes to achieve lower emissions must not impact the ability of the combustion system to satisfy performance and certification requirements throughout the operating cycle of the aircraft. Further, high bypass ratio turbine engines (e.g., bypass ratios greater than 9.0) require high fuel-air ratios and need multiple fuel-staging to meet NOₓ requirements.

Variations of two combustor architectures are used in turbine engine design to balance operational and environmental requirements: a rich-quench lean (RQL) combustor and a lean burn combustor. The RQL combustor operates as fuel-rich (e.g., excess fuel) mixture in a front-end primary zone that is directly downstream of the fuel injector and the swirler and provides flame stability over the range of combustor operation. As the fuel-rich mixture moves axially in the combustor, air jets are used to help close the primary zone recirculation zone and to provide additional air to continue reactions and also to quench the combustion gas to a lean mixture to reduce NOₓ emissions and reduce the highest temperature before the mixture exits the combustor. For example, the additional air from the air jets increases the amount of air in the fuel-air mixture changing the mixture from fuel-rich to fuel-lean. RQL combustors produce great amounts of soot in the fuel-rich primary zone, but NOₓ is reduced due to temperatures being low for fuel-rich mixtures. A rapid RQL quench zone design is needed in RQL combustors to balance a reduction of combustor hot spots and time at a temperature at which NOₓ is formed, while providing adequate temperature and time to burn out the soot and the nvPM formed in the primary zone.

Lean burn combustors avoid the high NOₓ formation zone resulting from high temperatures by starting lean and remaining lean at higher power outputs of the turbine engine. A small, fuel-rich flame, referred to as a pilot flame, is used that operates with a lower percentage of the total fuel and stabilizes the flame when in a lean burning mode. The pilot provides all of the fuel during low-power operation and part-power operation to maintain improved combustion efficiencies, and a main fuel circuit is opened to produce a main flame for higher power operation or mid-level power operation. Thus, the flame during the mid-level power operation and/or during the higher power operation includes the pilot flame and the main flame. A lean burn design provides all of the mixing in the front-end (e.g., the upstream end) of the combustor, which helps to reduce nvPM emissions by remaining fuel-lean and avoiding large combustor volumes of fuel-rich, high nvPM-producing zones in the combustor. When operating on pilot only flow at lower powers, the lean burn combustor produces non-zero nvPM as the pilot rich flame is quenched by the main air flow, similar to the RQL combustor.

As detailed above, there are tradeoffs in balancing NOₓ emissions, nvPM emissions, and carbon monoxide (CO) and unburned hydrocarbon (UHC) emissions in the combustion chamber. NOₓ is produced at high engine power levels, and the NOₓ is produced in the post-flame region of the combustion chamber, is temperature driven, and is time at temperature driven. For example, a greater amount of NOₓ is produced at higher temperatures and longer times at temperature. Current turbine engines control NOₓ emissions by reducing peak combustor temperatures and combustor residence time at those high temperatures. Reducing combustor residence time and combustor volume and length have the added benefit of reduced engine weight. For short combustor residence times and low combustion temperatures where NOₓ formation is low, however, CO and UHC emissions are higher due to incomplete combustion, and the combustor liner cooling air during low power ground operations can quench reactions of CO and UHC. Fuel-rich zones in the combustor form nvPM emissions, and increased time (combustor volume) is needed to oxidize the nvPM before being quenched in the downstream cooler region of the engine after exiting the combustor. Therefore, to balance all emissions requirements, turbine engine designs need an improved fuel and air placement in the dome region, an improved stoichiometry in the combustor, and improved residence time. Some turbine engines utilize leaner mixtures or changes in fuel spray at the upstream end of the combustor to reduce nvPM emissions. Such turbine engines, however, reduce operability and increase NOₓ emissions and require high fuel-air ratios for advanced thermodynamic cycles. Further, higher fuel-to-air ratios (e.g., greater than 0.031) at take-off are needed in such advanced engine thermodynamic cycles. Current combustor designs that utilize axial staging, traditional trapped vortex cavities, or the like, that utilize lower fuel-to-air ratios (e.g., less than or equal to 0.031) at take-off do not adequately optimize the stoichiometry of the combustor to meet required NOₓ emission targets when the fuel-to-air ratio is increased to the aforementioned higher values.

Embodiments of the present disclosure provide systems and methods to balance the requirements in turbine engines of low fuel burn and carbon dioxide (CO₂) emissions that are achieved with combustor fuel-air ratios, and other pollutant emissions, such as NOₓ emissions, that increase with temperature increases. Such a reduction in the various types of emissions is difficult to achieve when fuel burn and emissions need to be reduced over an entirety of a mission cycle of the turbine engine of an aircraft. The mission cycle includes low power operation, mid-level power operation, and high power operation. Low power operation includes, for example, engine start, idle, taxiing, and approach. Mid-level power operation includes, for example, cruise. High power operation includes, for example, takeoff and climb.

Embodiments of the present disclosure utilize a lean burn staged combustion system. Thus, the present disclosure provides for a multi-staged combustor with combustion gas injection for low NOₓ emissions (e.g., at least 50% below the regulations in the eleventh meeting of the Committee on Aviation Environmental Protection (CAEP/11) of the International Civil Aviation Organization (ICAO). For example, the multi-staged combustor includes both radial staging and axial staging of the fuel. The multi-staged combustor includes a nested flame structure produced by a first mixing assembly that includes a pilot mixer and a first main mixer encircling the pilot mixer for radial fuel staging and air staging. For example, the pilot mixer injects the fuel and the air axially from the pilot mixer and into the combustion chamber, and the first main mixer, located radially outward of the pilot mixer, injects the fuel and the air radially from the first main mixer and into the combustion chamber. The first mixing assembly is located at the annular dome that is positioned at a forward end (e.g., an upstream end) of the combustion chamber. The multi-staged combustor also includes a trapped vortex cavity (TVC) positioned axially aft, or axially downstream, of the first mixing assembly. The TVC is formed in the outer liner or the inner liner of the combustor includes a second mixing assembly that produces an auxiliary flame and includes a second main mixer. The second main mixer is disposed through the outer liner and/or the inner liner of the combustion chamber to inject fuel and air into the TVC. Compressed air is injected into the TVC to generate one or more vortices within the TVC such that the TVC “traps” the combustion process in the TVC and the auxiliary flame remains within the TVC. The TVC includes a TVC opening such that the TVC injects the combustion gases radially into the combustion chamber from the TVC. The first mixing assembly injects the fuel and the air into a first combustion zone, the second mixing assembly injects the fuel and the air into the TVC, and the TVC injects the combustion gases into a second combustion zone that is located axially aft, or axially downstream, of the first combustion zone. The nested flame provides lean combustion, and the combustion gases from the TVC that are injected downstream of the nested flame provides added flexibility of having even leaner combustion to reduce NOₓ emissions further than combustors without the benefit of the present disclosure (e.g., combustors with axial staging only and/or with only a TVC axially aligned with the first combustion zone). In this way, the radial staging and the axial staging (e.g., provided by the TVC) combined provides for improved stoichiometric capabilities in the combustor, while reducing NOₓ emissions, across the entire mission operating cycle of a turbine engine.

The combustor of the present disclosure allows for a majority (e.g., greater than 50%) of the fuel in the first mixing assembly (e.g., at the annular dome) and a smaller portion (e.g., about 20%) in the second mixing assembly at the TVC. Such a configuration allows the combustor to perform like a traditional lean burn combustor with additional fuel flow entering the second mixing assembly at the TVC for improved and leaner fuel and air mixing and lower NOₓ compared to combustors without the benefit of the present disclosure,

The TVC can include a plurality of TVCs such that each TVC defines a discrete combustion chamber therein. In some embodiments, the TVC is a singular, annular continuous cavity with a plurality of second mixing assemblies spaced circumferentially about the TVC. The TVC can produce a single vortex for trapping the combustion within the TVC or can include dual vortices that are either co-rotating or counterrotating. In some embodiments, the outer liner and/or the inner liner can include combustion holes and/or dilution holes provided upstream and/or downstream of the second main mixer. At low power engine operation, only the pilot mixer is used to produce a pilot flame. In some embodiments, both the pilot mixer and the first main mixer can be used during low power engine operation and the fuel and the air can be radially staged among the pilot mixer and the first main mixer for flame stability and/or to avoid lean blowout (LBO). At mid-power engine operation or high power engine operation, the pilot mixer, the first main mixer, and the second main mixer are operational at all operating conditions and the fuel splits and air splits are controlled to achieve combustion efficiency, reduced emissions, and improved operability of the combustor, as compared to combustors without the benefit of the present disclosure. The outer liner and the inner liner can be any shape, with split liner designs. The fuel can be any type of fuel used for turbine engines, such as, for example, JetA, sustainable aviation fuels (SAF) including biofuels, hydrogen-based fuel (H2), or the like.

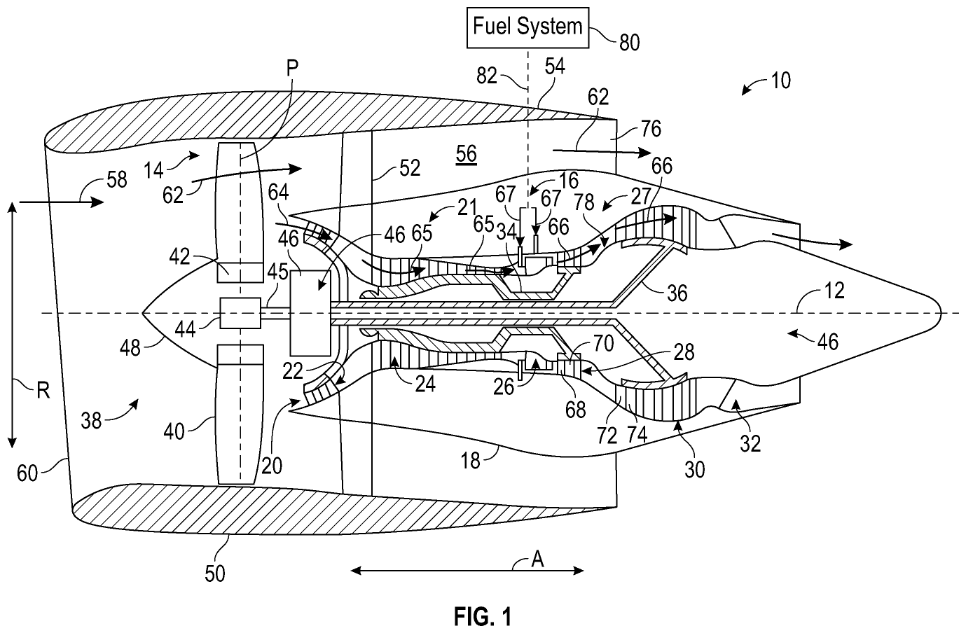

Referring now to the drawings, FIG. 1 is a schematic cross-sectional diagram of a turbine engine 10, taken along a longitudinal centerline axis 12 of the turbine engine 10, according to an embodiment of the present disclosure. As shown in FIG. 1, the turbine engine 10 defines an axial direction A (extending parallel to the longitudinal centerline axis 12 provided for reference) and a radial direction R that is normal to the axial direction A. In general, the turbine engine 10 includes a fan section 14 and a core turbine engine 16 disposed downstream from the fan section 14.

The core turbine engine 16 depicted generally includes an outer casing 18 that is substantially tubular and defines an annular inlet 20. As schematically shown in FIG. 1, the outer casing 18 encases, in serial flow relationship, a compressor section 21 including a booster or a low pressure (LP) compressor 22 followed downstream by a high pressure (HP) compressor 24, a combustion section 26, a turbine section 27 including a high pressure (HP) turbine 28 followed downstream by a low pressure (LP) turbine 30, and a jet exhaust nozzle section 32. A high pressure (HP) shaft 34 or spool drivingly connects the HP turbine 28 to the HP compressor 24 to rotate the HP turbine 28 and the HP compressor 24 in unison. A low pressure (LP) shaft 36 drivingly connects the LP turbine 30 to the LP compressor 22 to rotate the LP turbine 30 and the LP compressor 22 in unison. The compressor section 21, the combustion section 26, the turbine section 27, and the jet exhaust nozzle section 32 together define a core air flow path.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuation member 44 configured to collectively vary the pitch of the fan blades 40 in unison. The fan blades 40, the disk 42, and the actuation member 44 are together rotatable about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the core turbine engine 16. The nacelle 50 is supported relative to the core turbine engine 16 by a plurality of circumferentially spaced outlet guide vanes 52. Moreover, a downstream section 54 of the nacelle 50 extends over an outer portion of the core turbine engine 16 to define a bypass airflow passage 56 therebetween.

During operation of the turbine engine 10, a volume of air 58 enters the turbine engine 10 through an inlet 60 of the nacelle 50 and/or the fan section 14. As the volume of air 58 passes across the fan blades 40, a first portion of air 62 is directed or routed into the bypass airflow passage 56, and a second portion of air 64 is directed or is routed into the upstream section of the core air flow path, or, more specifically, into the annular inlet 20 of the LP compressor 22. The ratio between the first portion of air 62 and the second portion of air 64 is commonly known as a bypass ratio. The pressure of the second portion of air 64 is then increased, forming compressed air 65, and the compressed air 65 is routed through the HP compressor 24 and into the combustion section 26, where the compressed air 65 is mixed with fuel and burned to provide combustion gases 66.

The combustion gases 66 are routed into the HP turbine 28 and expanded through the HP turbine 28 where a portion of thermal energy and/or kinetic energy from the combustion gases 66 is extracted via sequential stages of HP turbine stator vanes 68 that are coupled to the outer casing 18 and HP turbine rotor blades 70 that are coupled to the HP shaft 34, thus, causing the HP shaft 34 to rotate, thereby supporting operation of the HP compressor 24. The combustion gases 66 are then routed into the LP turbine 30 and expanded through the LP turbine 30. Here, a second portion of thermal energy and/or the kinetic energy is extracted from the combustion gases 66 via sequential stages of LP turbine stator vanes 72 that are coupled to the outer casing 18 and LP turbine rotor blades 74 that are coupled to the LP shaft 36, thus, causing the LP shaft 36 to rotate, thereby supporting operation of the LP compressor 22 and rotation of the fan 38 via the gearbox assembly 46.

The combustion gases 66 are subsequently routed through the jet exhaust nozzle section 32 of the core turbine engine 16 to provide propulsive thrust. Simultaneously, the pressure of the first portion of air 62 is substantially increased as the first portion of air 62 is routed through the bypass airflow passage 56 before being exhausted from a fan nozzle exhaust section 76 of the turbine engine 10, also providing propulsive thrust. The HP turbine 28, the LP turbine 30, and the jet exhaust nozzle section 32 at least partially define a hot gas path 78 for routing the combustion gases 66 through the core turbine engine 16.

As detailed above, the second portion of air 64 is mixed with fuel 67 in the combustion section 26 to produce the combustion gases 66. The turbine engine 10 also includes a fuel system 80 for providing the fuel 67 to the combustion section 26. The fuel system 80 includes a fuel tank (not shown) for storing fuel therein and one or more fuel injector lines 82 to provide the fuel 67 to the combustion section 26, as detailed further below.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, turbojet engines, turboprop, and/or turboshaft engines.

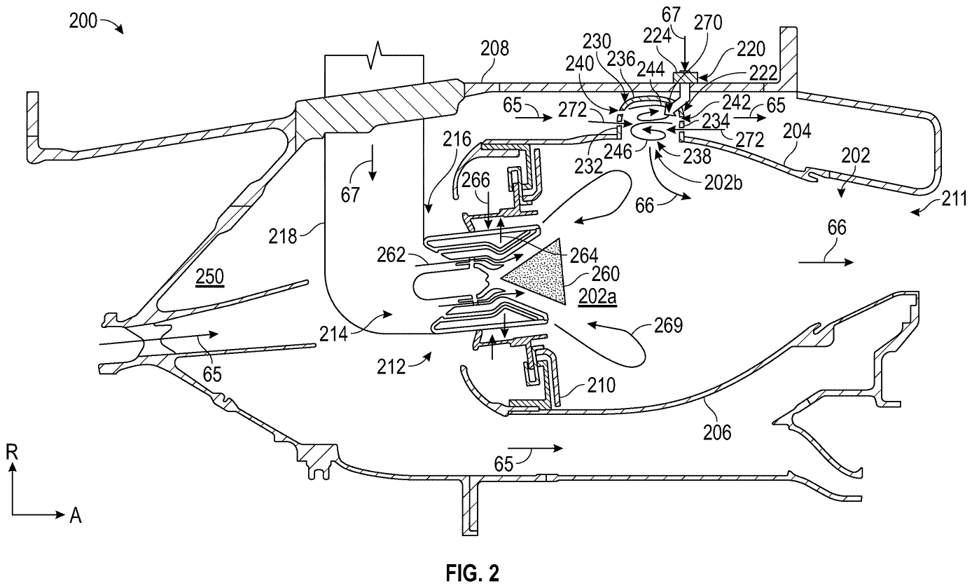

FIG. 2 is a schematic cross-sectional diagram of a combustor 200 for the turbine engine 10 (FIG. 1), taken along the longitudinal centerline axis 12 (FIG. 1) of the turbine engine 10 (FIG. 1). In the exemplary embodiment, the combustion section 26 (FIG. 1) includes the combustor 200 having a combustion chamber 202 defined by an outer liner 204 and an inner liner 206. The outer liner 204 and the inner liner 206 are annular about the longitudinal centerline axis 12 of the turbine engine 10 (FIG. 1). The outer liner 204 defines a radially outer boundary of the combustion chamber 202, and the inner liner 206 defines a radially inner boundary of the combustion chamber 202. The outer liner 204 and the inner liner 206 are spaced radially inward from an annular combustor casing 208 that extends circumferentially about the outer liner 204 and the inner liner 206. The combustor 200 also includes an annular dome 210 mounted upstream from the outer liner 204 and the inner liner 206. The annular dome 210 defines an upstream end of the combustion chamber 202. The combustion chamber 202 extends from the annular dome 210 to a combustion chamber outlet 211.

A plurality of first mixing assemblies 212 (only one is illustrated in FIG. 2) are spaced circumferentially about the annular dome 210 to deliver a first mixture of fuel and air to the combustion chamber 202. For example, the plurality of first mixing assemblies 212 delivers the first mixture of fuel and air into a first combustion zone 202a of the combustion chamber 202, as detailed further below. In FIG. 2, each first mixing assembly 212 is a twin annular premixing swirler (TAPS) that includes a pilot mixer 214 and a first main mixer 216. The first main mixer 216 is concentrically aligned with respect to the pilot mixer 214 and extends circumferentially about the pilot mixer 214. A plurality of first fuel injectors 218 (only one is illustrated in FIG. 2) are coupled in flow communication with each respective first mixing assembly 212. The plurality of first fuel injectors 218 are spaced circumferentially about the annular dome 210 and extend axially from the annular combustor casing 208 to the plurality of first mixing assemblies 212.

A plurality of second mixing assemblies 220 (only one illustrated in FIG. 2) are spaced circumferentially about the outer liner 204 to deliver a second mixture of fuel and air to the combustion chamber 202. For example, the plurality of second mixing assemblies 220 delivers the second mixture of fuel and air into a second combustion zone 202b of the combustion chamber 202, as detailed further below. The second combustion zone 202b is located axially aft of the first combustion zone 202a. In this way, the second combustion zone 202b is located downstream of the first combustion zone 202a. Each of the plurality of second mixing assemblies 220 includes a second main mixer 222. A plurality of second fuel injectors 224 (only one is illustrated in FIG. 2) are coupled in flow communication with each respective second mixing assembly 220. The plurality of second fuel injectors 224 are spaced circumferentially about the outer liner 204 and extend axially from the annular combustor casing 208 to the plurality of second mixing assemblies 220.

The combustor 200 includes a trapped vortex cavity (TVC) 230 formed in the outer liner 204 that defines the second combustion zone 202b. While one TVC 230 is shown and described in FIG. 2, the combustor 200 can include one or more TVCs 230. The TVC 230 is a cavity and is utilized to produce trapped vortices of a fuel-air mixture, as detailed further below. In FIG. 2, the TVC 230 is a dual trapped counter-rotating vortex cavity, as detailed further below. While FIG. 2 shows the TVC 230 formed in the outer liner 204, the TVC 230 can be formed in the inner liner 206. In some embodiments, both the outer liner 204 and the inner liner 206 include a TVC 230 formed therein. The TVC 230 is located axially aft of the annular dome 210. In this way, the TVC 230 is downstream of the annular dome 210. The TVC 230 is defined by a forward wall 232, an aft wall 234, and an axial wall 236 that extends axially from the forward wall 232 to the aft wall 234, and a TVC opening 238. The forward wall 232 and the aft wall 234 extend radially outward from the outer liner 204, and the axial wall 236 extends from the forward wall 232 to the aft wall 234, and the cavity is defined between the forward wall 232, the aft wall 234, and the axial wall 236. In this way, the TVC 230 is located radially outward from the combustion chamber 202. The TVC opening 238 is an opening in the outer liner 204 to provide flow communication from the TVC 230 to the combustion chamber 202. While the TVC 230 illustrated in FIG. 2 includes a substantially rectangular cross section, the TVC 230 can include any shape.

The TVC 230 includes one or more first air holes 240 in the forward wall 232 and one or more second air holes 242 in the aft wall 234. The one or more first air holes 240 operably direct the compressed air 65 through the forward wall 232 into the TVC 230 and generate a first vortex 244. The one or more second air holes 242 operably direct the compressed air 65 through the aft wall 234 into the TVC 230 and generate a second vortex 246. The first vortex 244 and the second vortex 246 are counter-rotating. In this way, the TVC 230 produces trapped dual counter-rotating vortices of a fuel-air mixture as shown in FIG. 2. In some embodiments, the TVC 230 is a single vortex structure such that the TVC 230 produces only a single vortex. For example, the TVC 230 includes only the one or more first air holes 240 for generating only the first vortex 244 or only the one or more second air holes 242 for generating only the second vortex 246.

The plurality of second mixing assemblies 220 are positioned to inject the fuel 67 into the TVC 230. A size of each of the one or more first air holes 240 and of the one or more second air holes 242, the number of the one or more first air holes 240 and of the one or more second air holes 242, and/or the circumferential spacing between respective ones of the one or more first air holes 240 and of the one or more second air holes 242, may be based on a desired amount of vortex airflow desired to generate the first vortex 244 and the second vortex 246 within the TVC 230. In addition, while FIG. 2 depicts the one or more first air holes 240 and of the one or more second air holes 242 as being generally circular openings, other shapes may be implemented for the openings instead. For example, the one or more first air holes 240 and of the one or more second air holes 242 may be oval-shaped slots, or the like. The second vortex 246 is located radially inward of the first vortex 244. In some embodiments, the first vortex 244 is located radially inward of the second vortex 246.

In operation, the combustor 200 receives compressed air 65 discharged from the HP compressor 24 (FIG. 1) in a diffuser section 250 at a location upstream of the combustion chamber 202. A portion of the compressed air 65 is channeled through the first mixing assembly 212. At the first mixing assembly 212, the compressed air 65 is mixed with the fuel 67 from the first fuel injector 218 and discharged into the combustion chamber 202. For example, the pilot mixer 214 mixes the compressed air 65 and the fuel 67 to generate a first mixture of compressed air 65 and fuel 67. The first mixture of compressed air 65 and fuel 67 is ignited by an igniter (not shown in FIG. 2 for clarity) creating a first flame within the combustion chamber 202 that burns the first mixture and provides combustion gases 66 that are channeled downstream to a first stage turbine nozzle of the HP turbine 28 (FIG. 1). The first flame is also referred to as a pilot flame. A portion of the compressed air 65 is also channeled through the first main mixer 216 and the first main mixer 216 mixes the compressed air 65 and the fuel 67 to generate a second mixture of compressed air 65 and fuel 67. The second mixture of compressed air 65 and fuel 67 is ignited by the igniter creating a second flame within the combustion chamber 202 that burns the second mixture and provides combustion gases 66 that are channeled downstream to the first stage turbine nozzle of the HP turbine 28. The second flame is referred to as a first main flame. The first flame and the second flame together are referred to as a nested flame. For example, a nested flame is when the pilot flame is at the center core of each fuel nozzle and the first main flame surrounds the pilot flame in the annular space about each fuel nozzle. In this way, the pilot flame is “nested” inside the first main flame. The nested flame (e.g., the first flame and the second flame) burns within the first combustion zone 202a.

A portion of the compressed air 65 is also injected through the one or more first air holes 240 and through the one or more second air holes 242 into the TVC 230. The second fuel injector 224 injects the fuel 67 into the TVC 230. In the TVC 230, the compressed air 65 is mixed with the fuel 67 from the second fuel injector 224 to produce a third mixture of compressed air 65 and fuel 67. The compressed air 65 injected into the TVC 230 produces the trapped dual counter-rotating vortices (e.g., the first vortex 244 and the second vortex 246). In this way, dual trapped counter-rotating vortices of fuel and air are formed in the TVC 230. The third mixture of compressed air 65 and fuel 67 is ignited by an igniter (not shown in FIG. 2 for clarity) creating a third flame within the TVC 230 that burns the third mixture and generates combustion gases 66. The first vortex 244 and the second vortex 246 trap the third flame within the TVC 230 such that the fuel-air mixture combusts entirely within the TVC 230 and produces the combustion gases 66 within the TVC 230. The TVC 230 injects the combustion gases 66 through the TVC opening 238 into the combustion chamber 202. The combustion gases 66 from the first combustion zone 202a mix with the combustion gases 66 from the second combustion zone 202b within the combustion chamber 202 and then exit the combustion chamber 202 through the combustion chamber outlet 211, and are channeled downstream to the first stage turbine nozzle of the HP turbine 28 (FIG. 1). The third flame is referred to as a second main flame or an auxiliary flame.

The combustor 200 is a hybrid staged combustor. In particular, the plurality of first mixing assemblies 212 provides for radial fuel staging at the annular dome 210 in the first combustion zone 202a, and the plurality of second mixing assemblies 220 provides for axial fuel staging in the second combustion zone 202b. For example, the TVC 230, the plurality of second mixing assemblies 220 and the second combustion zone 202b are located axially downstream of the plurality of first mixing assemblies 212 and the first combustion zone 202a, respectively. Such a configuration of the combustor 200 provides for lean combustion provided by the plurality of first mixing assemblies 212 (e.g., by radially staging the pilot mixer 214 and the first main mixer 216), and even leaner combustion provided by the plurality of second mixing assemblies 220 to reduce NOₓ emissions as compared to combustors without the benefit of the present disclosure, as detailed further below.

The combustor 200 is a lean burn combustor. Specifically, at engine start conditions and at an engine low power operation (e.g., less than 30% of a sea level static (SLS) maximum engine rated thrust) of the turbine engine 10 (FIG. 1), such as at idle, at taxi, or at approach, the combustor 200 uses only fuel 67 provided to the pilot mixer 214 for generating the combustion gases 66. At the pilot mixer 214, fuel 67 includes a pilot fuel stream 260 that is mixed with a first portion 262 of the compressed air 65 to provide a rich fuel-air mixture (e.g., higher fuel to air ratios within the mixture) that is ignited for a pilot flame within the first combustion zone 202a that is adjacent to the pilot mixer 214. The fuel-air mixture from the pilot mixer 214 is referred to as a pilot mixer fuel-air mixture.

In some embodiments, the combustor 200 can use fuel 67 split among the pilot mixer 214, the first main mixer 216, and/or the second main mixer 222 during the engine low power operation. For example, at the first main mixer 216, the fuel 67 includes a first main fuel stream 264 that is mixed with a second portion 266 of the compressed air 65 to provide a first lean fuel-air mixture (e.g., lower fuel to air ratios within the mixture) that is ignited for a first main flame within the first combustion zone 202a of the combustion chamber 202 that is adjacent to the first main mixer 216, thus, providing a lean burn combustion process to generate combustion gases 66 while reducing NOₓ emissions by operating fuel-lean, as detailed further below. Further, the lean burn combustion process provides for low non-volatile particulate matter (nvPM), such as soot or smoke, and reduces NOₓ emissions. The pilot mixer 214 injects the pilot fuel stream 260 generally axially from the first mixing assembly 212. The first main mixer 216 injects the first main fuel stream 264 radially outward from the first mixing assembly 212. In this way, the first mixing assembly 212 radially stages the fuel injection using the pilot mixer 214 (e.g., axial fuel injection) and the first main mixer 216 (e.g., radial fuel injection). The first main mixer 216 swirls the second portion 266 of the compressed air 65 in a first swirl direction to generate a swirler air flow 269 in the combustion chamber 202. The fuel-air mixture from the first main mixer 216 is referred to as a first main mixer fuel-air mixture.

At the second main mixer 222, the fuel 67 includes a second main fuel stream 270 that is mixed with a third portion 272 of the compressed air 65 (e.g., injected through the one or more first air holes 240 and/or the one or more second air holes 242) to provide a second lean fuel-air mixture (e.g., lower fuel to air ratios within the mixture) that is ignited for a second main flame within the TVC 230 that is adjacent the second main mixer 222, thus, providing a lean burn combustion process to generate combustion gases 66 while further reducing NOₓ emissions by operating fuel-lean. The second lean fuel-air mixture is more fuel-lean than the first lean fuel-air mixture. The second main mixer 222 injects the second main fuel stream radially inward into the TVC 230 that is axially downstream of the first lean fuel-air mixture. The combustion gases 66 produced in the TVC 230 are then injected into the combustion chamber 202 through the TVC opening 238 axially aft, or axially downstream, of the first combustion zone 202a, as detailed above. In this way, the combustor 200 provides for both radial staging (e.g., at the first mixing assembly 212) and axial staging (e.g., at the second mixing assembly 220) to provide for a greater reduction in NOₓ emissions compared to combustors without the benefit of the present disclosure. For example, the air splits and the fuel splits to the plurality of first mixing assemblies 212 and to the plurality of second mixing assemblies 220 can be controlled at different operating conditions of the combustor 200 to reduce the NOₓ emissions throughout the entire operating cycle of the combustor 200, as detailed further below. The fuel-air mixture from the second main mixer 222 is referred to as a second main mixer fuel-air mixture.

At a high power operation (e.g., greater than 85% of SLS maximum engine rated thrust) of the turbine engine 10 (FIG. 1), such as at takeoff or at climb, and at mid-level power operation (e.g., 30% to 85% of SLS maximum engine rated thrust) of the turbine engine 10 (FIG. 1), such as at cruise, the combustor 200 uses a fuel 67 split among the pilot mixer 214, the first main mixer 216, and the second main mixer 222 for generating the combustion gases 66 in the first combustion zone 202a and in the TVC 230. In this way, the combustor 200 permits control of the combustion dynamics in a radially-staged and axially-staged combustion configuration. The fuel split among the pilot mixer 214, the first main mixer 216, and the second main mixer 222 can be optimized to mitigate dynamics while also meeting combustor performance metrics for the various operating cycles of the turbine engine 10 (FIG. 1). For example, the fuel split among the pilot mixer 214, the first main mixer 216, and the second main mixer 222 is controlled to reduce NOₓ emissions during the entire operating cycle (e.g., idle, taxi, takeoff, climb, cruise, and approach). Staging in such a way (e.g., radially-staged and axially-staged) allows for higher mixer air flows so that the combustor 200 operates fuel-lean in both a forward portion and an aft portion of the combustor at high power conditions for operability while also reducing NOₓ emissions as compared to combustors without the benefit of the present disclosure that utilize axial staging only.

During operation, the compressed air 65 is split among the annular dome 210, the pilot mixer 214, the first main mixer 216, the second main mixer 222 (e.g., the TVC 230), between the outer liner 204 and the annular combustor casing 208, and between the inner liner 206 and the annular combustor casing 208. The compressed air 65 splits are selected to provide a lean combustor in both the first combustion zone 202a and the TVC 230 (e.g., from which the combustion gases 66 are injected into the second combustion zone 202b), as detailed further below. For example, the combustor 200, the annular dome 210, the plurality of first mixing assemblies 212, and the plurality of second mixing assemblies 220 are oriented and configured to provide 5% to 9% of the compressed air 65 to the annular dome 210, 7% to 20% of the compressed air 65 to the pilot mixer 214 (e.g., the first portion 262 of compressed air 65), 30% to 60% of the compressed air 65 to the first main mixer 216 (e.g., the second portion 266 of compressed air 65), 11% to 30% of the compressed air 65 to the second main mixer 222 (e.g., the third portion 272 of compressed air 65), 7% to 10% of the compressed air 65 to the outer liner 204 and the inner liner 206 in an area forward of the plurality of second mixing assemblies 220, and 6% to 9% of the compressed air 65 to the outer liner 204 and the inner liner 206 in an area aft of the plurality of second mixing assemblies 220.

The annular dome 210 can include one or more cooling holes to provide the compressed air 65 through the annular dome 210 into the combustion chamber 202 to cool a downstream side of the annular dome 210 (e.g., a side of the annular dome 210 that is exposed to the combustion chamber 202). The outer liner 204 can include one or more cooling holes located on the outer liner 204 forward and aft of the plurality of second mixing assemblies 220 to provide the compressed air 65 through the outer liner 204 into the combustion chamber 202 to cool an inner surface of the outer liner 204 (e.g., a surface of the outer liner 204 that is exposed to the combustion chamber 202). Similarly, the inner liner 206 can include one or more cooling holes located on the inner liner 206 forward and aft of the plurality of second mixing assemblies 220 to provide the compressed air 65 through the inner liner 206 into the combustion chamber 202 to cool an inner surface of the inner liner 206 (e.g., a surface of the inner liner 206 that is exposed to the combustion chamber 202).

The fuel 67 is split among the pilot mixer 214, the first main mixer 216, and the second main mixer 222 to provide lean combustion in the first combustion zone 202a and the TVC 230 to reduce NOₓ emissions. For example, the pilot fuel stream 260 includes 90% to 100% of the fuel 67 during idle conditions of the turbine engine, 35% to 50% of the fuel during approach conditions of the turbine engine, 20% to 40% of the fuel during cruise conditions of the turbine engine, and 5% to 20% of the fuel during climb conditions or take-off conditions of the turbine engine. The first main fuel stream 264 includes 0% to 5% of the fuel during idle conditions of the turbine engine, 50% to 58% of the fuel during approach conditions of the turbine engine, 55% to 70% of the fuel during cruise conditions of the turbine engine, and 65% to 72% of the fuel during climb conditions or take-off conditions of the turbine engine. The second main fuel stream includes 0% to 5% of the fuel during idle conditions of the turbine engine, 0% to 7% of the fuel during approach conditions of the turbine engine, 5% to 10% of the fuel during cruise conditions of the turbine engine, and 15% to 23% of the fuel during climb conditions or take-off conditions of the turbine engine. The fuel splits are selected to be fuel-rich for good operability at low power operation (e.g., idle, taxi, approach, etc.) and to be fuel-lean at mid-power operation (e.g., cruise) and high power operation (e.g., take-off or climb) for low NOₓ emissions.

The fuel-air mixture for each of the pilot mixer 214, the first main mixer 216, and the second main mixer 222 is defined by an equivalence ratio. The equivalence ratio is an actual fuel-air ratio (e.g., the fuel-air splits detailed above) to a stoichiometric fuel-air ratio. The actual fuel-air ratio is the fuel-air ratio provided to each of the pilot mixer 214, the first main mixer 216, and the second main mixer 222. The stoichiometric fuel-air ratio is an ideal fuel-air ratio that burns all fuel with no excess air. If the equivalence ratio is less than one, the combustion is considered lean with excess air, and if the equivalence ratio is greater than one, the combustion is considered rich with incomplete combustion.

In general, for the pilot mixer 214, the pilot mixer equivalence ratio decreases from idle, to approach, to cruise, to climb, and to take-off. For example, the pilot mixer 214 operates fuel-rich (e.g., the pilot mixer equivalence ratio is greater than one) for the operating cycle of the turbine engine 10 (FIG. 1) and, in some embodiments, can operate fuel-lean (e.g., the pilot mixer equivalence ratio is less than one) during high power operation. In general, for the first main mixer 216, the first main mixer equivalence ratio increases from idle, to approach, to cruise, to climb, to take-off. For example, the first main mixer 216 operates fuel-lean (e.g., the first main mixer equivalence ratio is less than one) for the entire operating cycle of the turbine engine 10 (FIG. 1). In general, for the second main mixer 222, the second main mixer equivalence ratio increases from idle, to approach, to cruise, to climb, and to take-off. For example, the second main mixer 222 operates fuel-lean (e.g., the second main mixer equivalence ratio is less than one) for the entire operating cycle of the turbine engine 10 (FIG. 1). The second main mixer 222 operates more fuel-lean than the first main mixer 216 (e.g., the second main mixer equivalence ratio is less than the first main mixer equivalence ratio). In this way, the pilot mixer 214 is fuel-rich at low power operation for operability of the combustor 200, and the first main mixer 216 and the second main mixer 222 are fuel-lean during high power operation for low NOₓ emissions. Further, since the second main mixer 222 is positioned downstream within the combustor 200, the combustion process generated by the second main mixer 222 has a short residence time compared to the residence time of the first main mixer 216 (e.g., located at a forward end of the combustor 200). In this way, the second main mixer 222 operates fuel-lean so as to not inject a rich streak of fuel downstream within the combustion chamber 202.

In some embodiments, the compressed air 65 and the fuel 67 are split between the pilot mixer 214 and the second main mixer 222 to provide rich burn combustion in the first combustion zone 202a and lean burn combustion in the second combustion zone 202b to reduce NOₓ emissions. For example, the compressed air 65 splits are selected to provide a rich burn combustor in the first combustion zone 202a and lean burn in the TVC 230 (e.g., from which the combustion gases 66 are injected into the second combustion zone 202b). Such a configuration is referred to as a first rich dome embodiment. For example, the combustor 200, the annular dome 210, the plurality of first mixing assemblies 212, and the plurality of second mixing assemblies 220 are oriented and configured to provide 5% to 9% of the compressed air 65 to the annular dome 210, 12% to 20% of the compressed air 65 to the pilot mixer 214 (e.g., the first portion 262 of compressed air 65), 15% to 30% of the compressed air 65 to the second main mixer 222 (e.g., the third portion 272 of compressed air 65), 35% to 50% of the compressed air 65 to dilution holes (e.g., dilution holes that extend through the inner liner, the outer liner, and/or the walls that define the TVC), 7% to 10% of the compressed air 65 as cooling air to the outer liner 204 and the inner liner 206 in an area forward of the plurality of second mixing assemblies 220, and 6% to 9% of the compressed air 65 as cooling air to the outer liner 204 and the inner liner 206 in an area aft of the plurality of second mixing assemblies 220.

In the first rich dome embodiment, the pilot fuel stream 260 includes 95% to 100% of the fuel 67 during idle conditions of the turbine engine, 95% to 100% of the fuel during approach conditions of the turbine engine, 95% to 100% of the fuel during cruise conditions of the turbine engine, and 65% to 80% of the fuel during climb conditions or take-off conditions of the turbine engine. The first main fuel stream 264 does not operate in the rich dome embodiments. The second main fuel stream includes 0% to 5% of the fuel during idle conditions of the turbine engine, 0% to 5% of the fuel during approach conditions of the turbine engine, 0% to 5% of the fuel during cruise conditions of the turbine engine, and 20% to 35% of the fuel during climb conditions or take-off conditions of the turbine engine.

In general, for the pilot mixer 214, the pilot mixer equivalence ratio increases from idle, to approach, to cruise, to climb, and to take-off. For example, the pilot mixer 214 generates a rich burn for the operating cycle of the turbine engine 10 (FIG. 1). In general, for the second main mixer 222, the second main mixer equivalence ratio increases from idle, to approach, to cruise, to climb, and to take-off. For example, the second main mixer 222 generates a lean burn for the entire operating cycle of the turbine engine 10 (FIG. 1).

In a second rich dome embodiment, the compressed air 65 and the fuel 67 are split between the pilot mixer 214 and the second main mixer 222 to provide a combination of rich burn combustion and lean burn combustion in the combustion chamber 202 to reduce NOₓ emissions. For example, the compressed air 65 splits are selected to provide a rich burn combustor in the first combustion zone 202a and a lean burn in the TVC 230 (e.g., from which the combustion gases 66 are injected into the second combustion zone 202b). For example, in the second rich dome embodiment, the annular dome 210, the plurality of first mixing assemblies 212 and the plurality of second mixing assemblies 220 are oriented and configured to provide 5% to 9% of the compressed air 65 to the annular dome 210, 12% to 20% of the compressed air 65 to the pilot mixer 214 (e.g., the first portion 262 of compressed air 65), 45% to 65% of the compressed air 65 to the second main mixer 222 (e.g., the third portion 272 of compressed air 65), 5% to 15% of the compressed air 65 to the dilution holes, 7% to 9% of the compressed air 65 as cooling air to the outer liner 204 and the inner liner 206 in an area forward of the plurality of second mixing assemblies 220, and 7% to 9% of the compressed air 65 as cooling air to the outer liner 204 and the inner liner 206 in an area aft of the plurality of second mixing assemblies 220.

In the second rich dome embodiment, the pilot fuel stream 260 includes 80% to 100% of the fuel 67 during idle conditions of the turbine engine, 40% to 100% of the fuel during approach conditions of the turbine engine, 15% to 50% of the fuel during cruise conditions of the turbine engine, and 15% to 50% of the fuel during climb conditions or take-off conditions of the turbine engine. The first main fuel stream 264 does not operate in the rich dome embodiments. The second main fuel stream includes 0% to 20% of the fuel during idle conditions of the turbine engine, 0% to 60% of the fuel during approach conditions of the turbine engine, 50% to 85% of the fuel during cruise conditions of the turbine engine, and 50% to 85% of the fuel during climb conditions or take-off conditions of the turbine engine.

In general, for the pilot mixer 214, the pilot mixer equivalence ratio decreases from idle, to approach, to cruise, and increases from cruise to climb, and to take-off. For example, the pilot mixer 214 generates a rich burn for the operating cycle of the turbine engine 10 (FIG. 1). In some instances, the pilot mixer 214 can operate fuel-lean. In general, for the second main mixer 222, the second main mixer equivalence ratio increases from idle, to approach, to cruise, to climb, and to take-off. For example, the second main mixer 222 generates a lean burn for the entire operating cycle of the turbine engine 10 (FIG. 1).

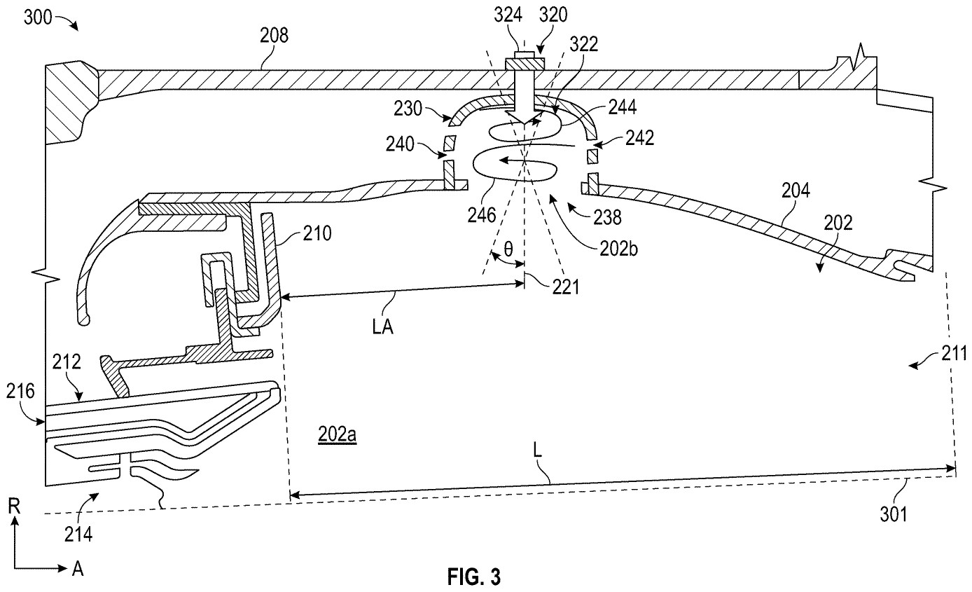

FIG. 3 is an enlarged, schematic cross-sectional view of a combustor 300, taken along a longitudinal centerline axis 301 of the combustor 300, according to another embodiment. The combustor 300 is shown schematically in FIG. 3 and some components are not shown or labeled for clarity. The combustor 300 includes many of the same or similar components as the combustor 200 of FIG. 2. The combustor 300 includes a plurality of second mixing assemblies 320 each having a second main mixer 322 and a fuel injector 324. The plurality of second mixing assemblies 320 can be oriented at a first angle θ with respect to the radial direction R. In FIG. 3, the first angle θ of the plurality of second mixing assemblies 320 is 0° such that the plurality of second mixing assemblies 320 is parallel to the radial direction R. As shown by the dashed lines, however, the first angle θ can be positive or negative such that the plurality of second mixing assemblies 320 (shown in dashed lines in a positive orientation and in a negative orientation) injects the fuel 67 into the TVC 230 at the first angle θ with respect to the radial direction R. The first angle θ is in a range from −60° to 60°. Such a range of the first angle θ provides for greater mixing of the combustion gases generated by the plurality of second mixing assemblies 320 and the combustion gases generated by the plurality of first mixing assemblies 212 as compared to values of the first angle θ that are outside (e.g., greater than or less than) the range.

The combustion chamber 202 includes a length L measured in the axial direction A from the annular dome 210 to the combustion chamber outlet 211. The plurality of second mixing assemblies 320 are disposed at an axial location on the combustion chamber 202. The plurality of second mixing assemblies 320 are disposed at an axial length L_{A} measured from the annular dome 210 to a longitudinal centerline axis 221 of the plurality of second mixing assemblies 320. A ratio of the axial length L_{A} to the length L of the combustion chamber 202 (L_{A}/L) is in a range of 0.2 to 0.8. Such a range of L_{A}/L provides for an axial location of the plurality of second mixing assemblies 320 such that the combustion gases from the plurality of second mixing assemblies 320 adequately mix with the combustion gases from the plurality of first mixing assemblies 212 prior to entering the turbine section 27 (FIG. 1), while also being downstream from the plurality of first mixing assemblies 212 such that the combustion process generated by the plurality of second mixing assemblies 320 does not interfere with the combustion process of the plurality of first mixing assemblies 212.

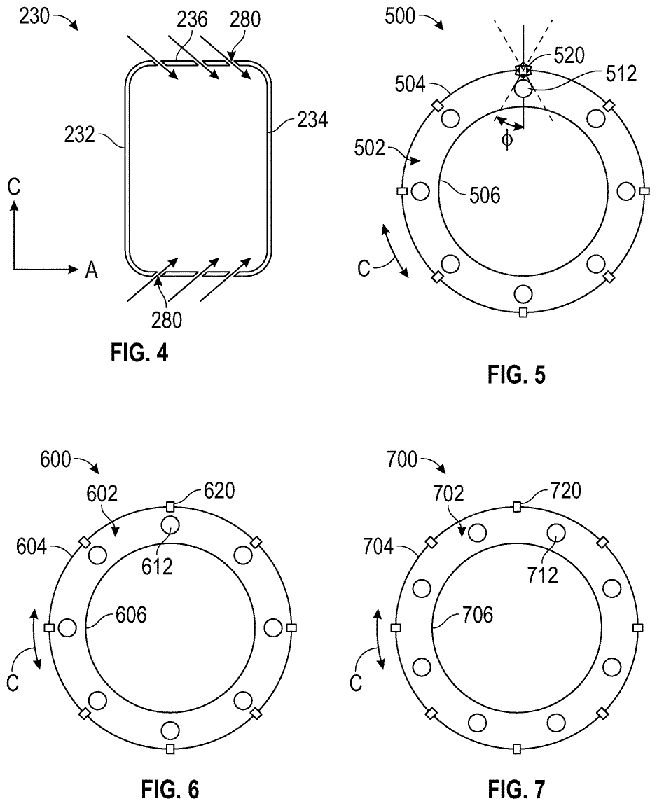

FIG. 4 is a schematic top view of a single, discrete TVC 230, according to the present disclosure. As shown in FIG. 4, the TVC 230 is generally rectangular. The TVC 230, however, can include any shape. The TVC 230 includes one or more cooling holes 280 extending through the axial wall 236 of the TVC 230. The one or more cooling holes 280 are angled with respect to axial direction A to operably direct the compressed air 65 therethrough at an angle. The one or more cooling holes 280 can be disposed at any angle with respect to the axial direction A or the circumferential direction C, as desired, to provide cooling air to the TVC 230.

FIG. 5 is a schematic front view of a combustor 500, according to another embodiment. The combustor 500 is substantially similar to the combustor 200 of FIG. 2. For example, the combustor 500 includes a combustion chamber 502, an outer liner 504, an inner liner 506, a plurality of first mixing assemblies 512, and a plurality of second mixing assemblies 520. The plurality of second mixing assemblies 520 are oriented at a second angle φ with respect to the circumferential direction C. As shown by the dashed lines, the second angle φ can be positive or negative such that the plurality of second mixing assemblies 520 injects the fuel at the second angle φ with respect to the circumferential direction C. The second angle φ is in a range from −80° to 80°. Such a range of the second angle φ provides for greater mixing of the combustion gases generated by the plurality of second mixing assemblies 520 and the combustion gases generated by the plurality of first mixing assemblies 512 as compared to values of the second angle φ that are outside (e.g., greater than or less than) the range.

FIG. 6 is a schematic front view of a combustor 600, according to another embodiment. The combustor 600 is substantially similar to the combustor 200 of FIG. 2. For example, the combustor 600 includes a combustion chamber 602, an outer liner 604, an inner liner 606, a plurality of first mixing assemblies 612, and a plurality of second mixing assemblies 620. As shown in FIG. 6, the plurality of first mixing assemblies 612 and the plurality of second mixing assemblies 620 are circumferentially aligned about the circumferential direction C. Aligning the plurality of first mixing assemblies 612 and the plurality of second mixing assemblies 620 circumferentially allows the combustion gases generated by the plurality of first mixing assemblies 612 to mix with the combustion gases generated by the plurality of second mixing assemblies 620 for a complete reaction prior to exiting the combustion chamber 602.

FIG. 7 is a schematic front view of a combustor 700, according to another embodiment. The combustor 700 is substantially similar to the combustor 200 of FIG. 2. For example, the combustor 700 includes a combustion chamber 702, an outer liner 704, an inner liner 706, a plurality of first mixing assemblies 712, and a plurality of second mixing assemblies 720. As shown in FIG. 7, the plurality of first mixing assemblies 712 and the plurality of second mixing assemblies 720 are circumferentially misaligned about the circumferential direction C. Misaligning the plurality of first mixing assemblies 712 and the plurality of second mixing assemblies 720 circumferentially reduces the interaction of the plurality of first mixing assemblies 712 and the plurality of second mixing assemblies 720 so the combustion process of the plurality of second mixing assemblies 720 does not interfere with the combustion process of the plurality of second mixing assemblies 720.

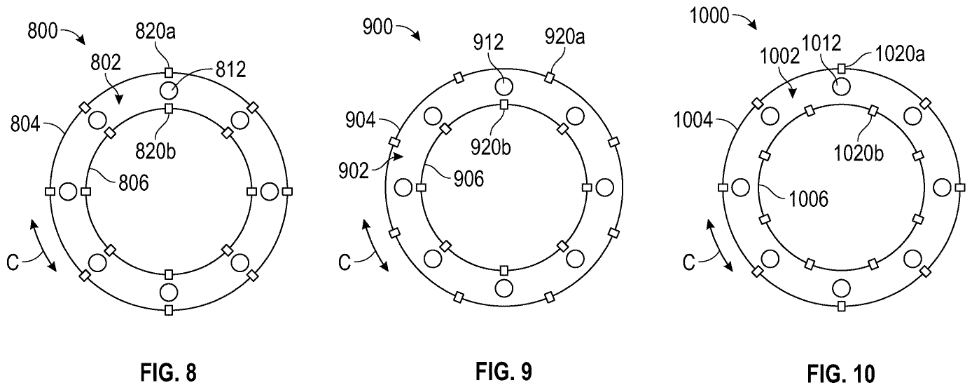

FIG. 8 is a schematic front view of a combustor 800, according to another embodiment. The combustor 800 is substantially similar to the combustor 200 of FIG. 2. For example, the combustor 800 includes a combustion chamber 802, an outer liner 804, an inner liner 806, a plurality of first mixing assemblies 812, a first plurality of second mixing assemblies 820a, and a second plurality of second mixing assemblies 820b. As shown in FIG. 8, the plurality of first mixing assemblies 812, the first plurality of second mixing assemblies 820a, and the second plurality of second mixing assemblies 820b are circumferentially aligned about the circumferential direction C.

FIG. 9 is a schematic front view of a combustor 900, according to another embodiment. The combustor 900 is substantially similar to the combustors 200 of FIG. 2. For example, the combustor 900 includes a combustion chamber 902, an outer liner 904, an inner liner 906, a plurality of first mixing assemblies 912, a first plurality of second mixing assemblies 920a, and a second plurality of second mixing assemblies 920b. As shown in FIG. 9, the plurality of first mixing assemblies 912 and the second plurality of second mixing assemblies 920b are circumferentially aligned about the circumferential direction C, while the first plurality of second mixing assemblies 920a are circumferentially misaligned with the first mixing assemblies 912 and the second plurality of second mixing assemblies 920b.

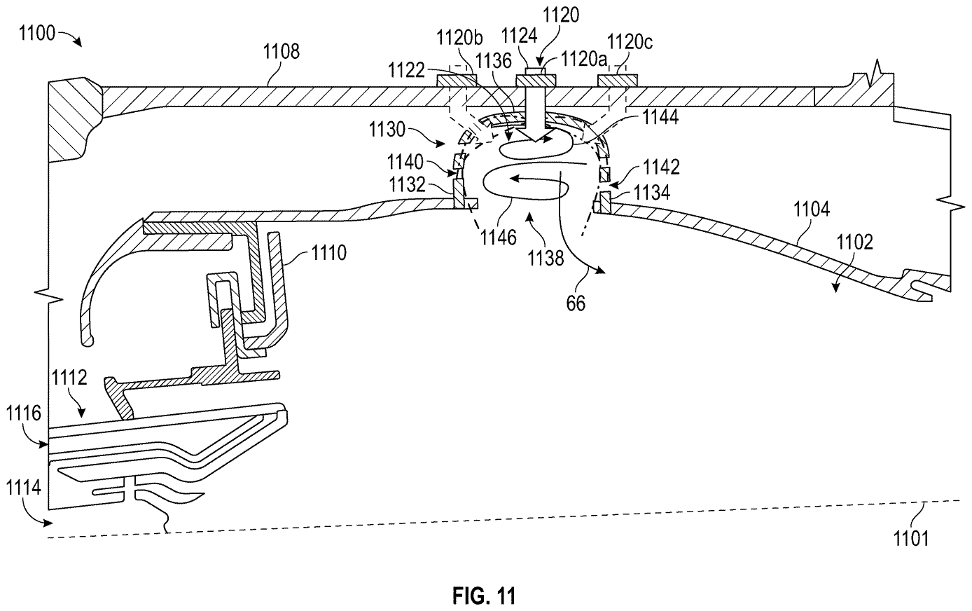

FIG. 10 is a schematic front view of a combustor 1000, according to another embodiment. The combustor 1000 is substantially similar to the combustor 200 of FIG. 2. For example, the combustor 1000 includes a combustion chamber 1002, an outer liner 1004, an inner liner 1006, a plurality of first mixing assemblies 1012, a first plurality of second mixing assemblies 1020a, and a second plurality of second mixing assemblies 1020b. As shown in FIG. 10, the plurality of first mixing assemblies 1012 and the first plurality of second mixing assemblies 1020a are circumferentially aligned about the circumferential direction C, while the second plurality of second mixing assemblies 1020b are circumferentially misaligned with the plurality of first mixing assemblies 1012 and the first plurality of second mixing assemblies 1020a.

FIG. 11 is an enlarged, schematic, cross-sectional view of a combustor 1100, taken along a longitudinal centerline axis 1101 of the combustor 1100, according to another embodiment. The view of FIG. 11 shows a top half (e.g., in the orientation shown in FIG. 11) of the combustor 1100 above the longitudinal centerline axis 1101. The combustor 1100 is substantially similar to the combustor 200 of FIG. 2. The combustor 1100 includes a combustion chamber 1102, an outer liner 1104, an inner liner (not shown in the view of FIG. 11), an annular combustor casing 1108, an annular dome 1110, a plurality of first mixing assemblies 1112 each having a pilot mixer 1114 and a first main mixer 1116, a first fuel injector (not shown in the view of FIG. 11), a plurality of second mixing assemblies 1120 each having a second main mixer 1122 and a second fuel injector 1124, and a trapped vortex cavity (TVC) 1130. The TVC 1130 is substantially similar to the TVC 230 of FIG. 2. The TVC 1130 is defined by a forward wall 1132, an aft wall 1134, an axial wall 1136, and a TVC opening 1138. The TVC 1130 also includes one or more first air holes 1140 extending through the forward wall 1132 and one or more second air holes 1142 extending through the aft wall 1134. The one or more first air holes 1140 and the one or more second air holes 1142 operably direct the compressed air 65 therethrough and into the TVC 1130 to generate a first vortex 1144 and a second vortex 1146.

The plurality of second mixing assemblies 1120 is coupled to the annular combustor casing 1108 and extend through the axial wall 1136 to inject the fuel and air into the TVC 1130. As shown in FIG. 11, the plurality of second mixing assemblies 1120 can be located at any axial location on axial wall 1136 of the TVC 1130, as shown by optional embodiments 1120a, 1120b, and 1120c. For example, in a first embodiment 1120a, the plurality of second mixing assemblies 1120 is located at an axial center of the TVC 1130 and extended substantially radially through the axial wall 1136such that the second fuel injector 1124 injects the fuel substantially radially into the TVC 1130. In a second embodiment 1120b, the plurality of second mixing assemblies 1120 is located at an axial forward end of the TVC 1130 on the axial wall 1136 and extend at an angle such that the second fuel injector 1124 injects the fuel axially aft and radially inward into the TVC 1130. In a third embodiment 1120c, the plurality of second mixing assemblies 1120 are located at an axial aft end of the TVC 1130 on the axial wall 1136 and extend at an angle such that the second fuel injector 1124 injects the fuel axially forward and radially inward into the TVC 1130. The location of the one or more mixing assemblies 1120 is selected to provide for efficient combustion and fuel-air mixing, while reducing NOₓ production.

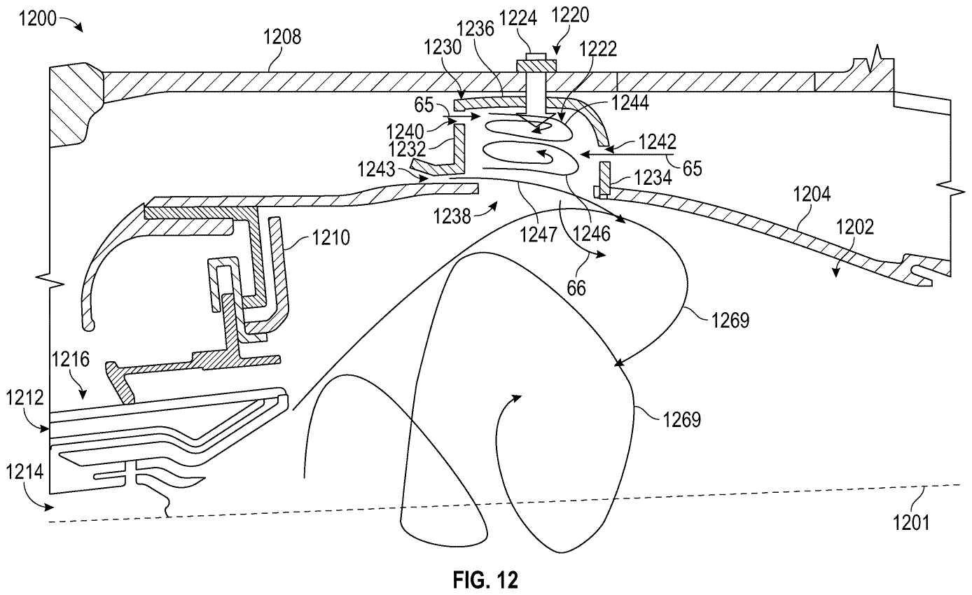

FIG. 12 is an enlarged, schematic, cross-sectional view of a combustor 1200, taken along a longitudinal centerline axis 1201 of the combustor 1200, according to another embodiment. The view of FIG. 12 shows a top half (e.g., in the orientation shown in FIG. 12) of the combustor 1200 above the longitudinal centerline axis 1201. The combustor 1200 is substantially similar to the combustor 200 of FIG. 2. The combustor 1200 includes a combustion chamber 1202, an outer liner 1204, an inner liner (not shown in the view of FIG. 12), an annular combustor casing 1208, an annular dome 1210, a plurality of first mixing assemblies 1212 each having a pilot mixer 1214 and a first main mixer 1216, a first fuel injector (not shown in the view of FIG. 12), a plurality of second mixing assemblies 1220 each having a second main mixer 1222 and a second fuel injector 1224, and a trapped vortex cavity (TVC) 1230. The TVC 1230 is substantially similar to the TVC 230 of FIG. 2. The TVC 1230 is defined by a forward wall 1232, an aft wall 1234, an axial wall 1236, and a TVC opening 1238. The TVC 1230 also includes one or more first air holes 1240 extending through the forward wall 1232 and one or more second air holes 1242 extending through the aft wall 1234. The one or more first air holes 1240 and the one or more second air holes 1242 operably direct the compressed air 65 therethrough and into the TVC 1230 to generate a first vortex 1244 and a second vortex 1246.

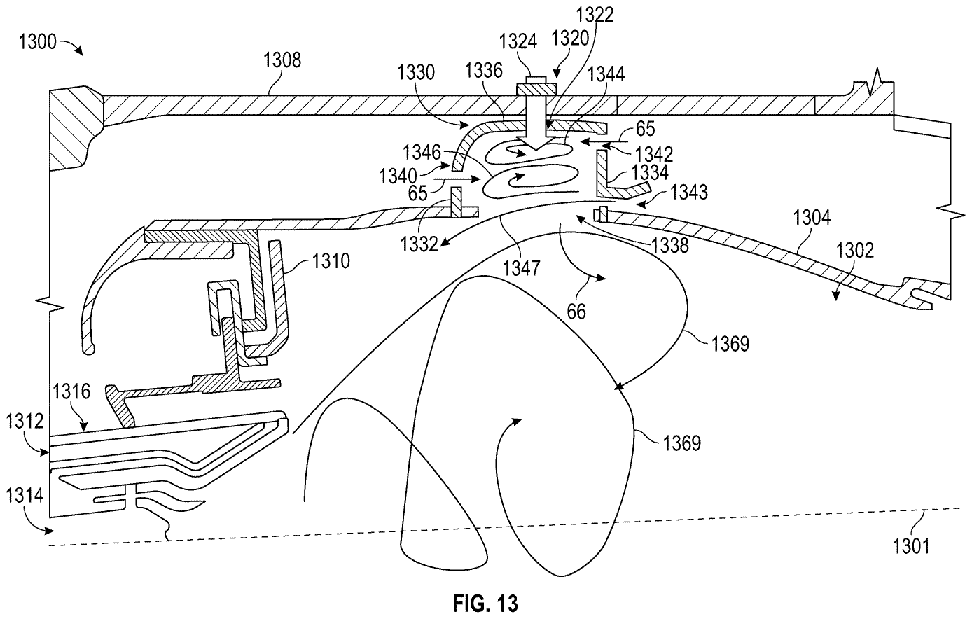

One or more air slots 1243 are in fluid communication with the TVC 1230. The one or more air slots 1243 are formed by the forward wall 1232. For example, the forward wall 1232 is radially separated from the outer liner 1204 to define the one or more air slots 1243 radially between the forward wall 1232 and the outer liner 1204. The one or more air slots 1243 operably direct the compressed air 65 therethrough to generate an air chute 1247. The air chute 1247 functions as a curtain of air at the TVC opening 1238 to separate the TVC 1230 from a swirler air flow 1269 from the plurality of first mixing assemblies 1212. The air chute 1247 can flow the entire circumferential width of the TVC 1230 via a single, annular air slot 1243 or can be segmented circumferentially via multiple, discrete air slots 1243 to permit hot gas exchange with the swirler air flow 1269. The air chute 1246 flows from forward to aft, thereby allowing for a higher pressure air flow as compared to the embodiment of FIG. 13 detailed below, and, thus, allows for a high pressure air chute 1247 for preventing the swirler air flow 1269 from entering the TVC 1230.

FIG. 13 is an enlarged, schematic, cross-sectional view of a combustor 1300, taken along a longitudinal centerline axis 1301 of the combustor 1300, according to another embodiment. The view of FIG. 13 shows a top half (e.g., in the orientation shown in FIG. 13) of the combustor 1300 above the longitudinal centerline axis 1301. The combustor 1300 is substantially similar to the combustors 200, 1200 of FIGS. 2 and 12, respectively. The combustor 1300 includes a combustion chamber 1302, an outer liner 1304, an inner liner (not shown in the view of FIG. 13), an annular combustor casing 1308, an annular dome 1310, a plurality of first mixing assemblies 1312 each having a pilot mixer 1314 and a first main mixer 1316, a first fuel injector (not shown in the view of FIG. 13), a plurality of second mixing assemblies 1320 each having a second main mixer 1322 and a second fuel injector 1324, and a trapped vortex cavity (TVC) 1330. The TVC 1330 is substantially similar to the TVCs 230, 1230 of FIGS. 2 and 12, respectively. The TVC 1330 is defined by a forward wall 1332, an aft wall 1334, an axial wall 1336, and a TVC opening 1338. The TVC 1330 also includes one or more first air holes 1340 extending through the forward wall 1332 and one or more second air holes 1342 extending through the aft wall 1334. The one or more first air holes 1340 and the one or more second air holes 1342 operably direct the compressed air 65 therethrough and into the TVC 1330 to generate a first vortex 1344 and a second vortex 1346.

One or more air slots 1343 are in fluid communication with the TVC 1330. The one or more air slots 1343 are formed by the aft wall 1334. For example, the aft wall 1334 is radially separated from the outer liner 1304 to define the one or more air slots 1343 radially between the aft wall 1334 and the outer liner 1304. The one or more air slots 1343 operably direct the compressed air 65 therethrough to generate an air chute 1347. The air chute 1347 functions as a curtain of air at the TVC opening 1338 to separate the TVC 1330 from a swirler air flow 1369 from the plurality of first mixing assemblies 1312. The air chute 1347 can flow the entire circumferential width of the TVC 1330 via a single, annular air slot 1343 or can be segmented circumferentially via multiple, discrete air slots 1343 to permit hot gas exchange with the swirler air flow 1369. The air chute 1346 flows from aft to forward, thereby allowing for a lower pressure air flow as compared to the air chute 1246 of FIG. 12, and, thus, higher pressure air flow can be directed through the one or more first air holes 1340.

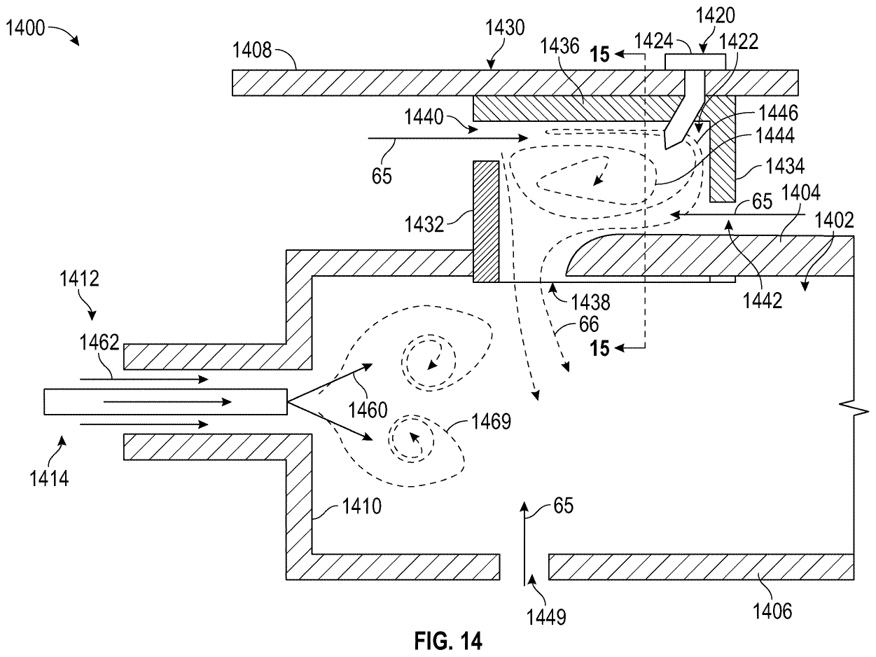

FIG. 14 is a partial, schematic, cross-sectional view of a combustor 1400 for a turbine engine, taken along a longitudinal centerline axis of the turbine engine, according to another embodiment. The combustor 1400 is substantially similar to the combustor 200 of FIG. 2, and can be used in the turbine engine 10 (FIG. 1). The combustor 1400 includes a combustion chamber 1402, an outer liner 1404, an inner liner 1406, an annular combustor casing 1408, an annular dome 1410, a plurality of first mixing assemblies 1412 each having a pilot mixer 1414 and a first main mixer (not shown in the view of FIG. 14 for clarity), a first fuel injector (not shown in the view of FIG. 14 for clarity), a plurality of second mixing assemblies 1420 each having a second main mixer 1422 and a second fuel injector 1424, and one or more trapped vortex cavities (TVCs) 1430. A first portion 1462 of the compressed air 65 is provided to the pilot mixer 1414 and a pilot fuel stream 1460 of the fuel 67 is provided to the pilot mixer 1414 to generate a fuel-air mixture for combustion in the combustion chamber 1402. The pilot mixer 1414 swirls the first portion 1462 of compressed air 65 to generate a swirl air flow 1469 within the combustion chamber 1402. The first main mixer is substantially similar to the first main mixer 216 of FIG. 2.

The one or more TVCs 1430 are substantially similar to the TVC 230 of FIG. 2. The one or more TVCs 1430 each are defined a forward wall 1432, an aft wall 1434, an axial wall 1436, and a TVC opening 1438. The outer liner 1404 extends axially into the TVC 1430 such that the outer liner 1404 and the forward wall 1432 define the TVC opening 1438. In this way, the TVC opening 1438 functions as a nozzle to inject the combustion gases 66 from the TVC 1430 into the combustion chamber 1402.

The one or more TVCs 1430 also includes one or more first air holes 1440 extending through the forward wall 1432 and one or more second air holes 1442 extending through the aft wall 1434. The one or more first air holes 1440 and the one or more second air holes 1442 operably direct the compressed air 65 therethrough and into the TVC 1430 to generate a first vortex 1444 and a second vortex 1446. The one or more first air holes 1440 and the one or more second air holes 1442 each includes discrete slots spaced circumferentially about the one or more TVCs 1430, as detailed further below. For example, the one or more first air holes 1440 are forward slots in forward wall 1432 of the TVC 1430 and the one or more second air holes 1442 are aft slots in aft wall 1434 of the TVC 1430. The one or more first air holes 1440 are positioned radially outward of the one or more second air holes 1442. For example, the one or more forward slots are formed between the axial wall 1436 and the forward wall 1432, and the one or more aft slots are formed between the outer liner 1404 and the aft wall 1434.

The combustor 1400 includes one or more dilution holes 1449 extending through the inner liner 1406. The one or more dilution holes 1449 operably direct the compressed air 65 through the inner liner 1406 into the combustion chamber 1402 to provide additional air for combustion. In this way, the compressed air 65 is referred to as dilution air and assists in profile trimming (e.g., moving a peak of a combustor exit temperature radial profile to a radial center of the combustor or to an outer span or an inner span by changing the air flow through the one or more dilution holes 1449 on the inner liner 1406)

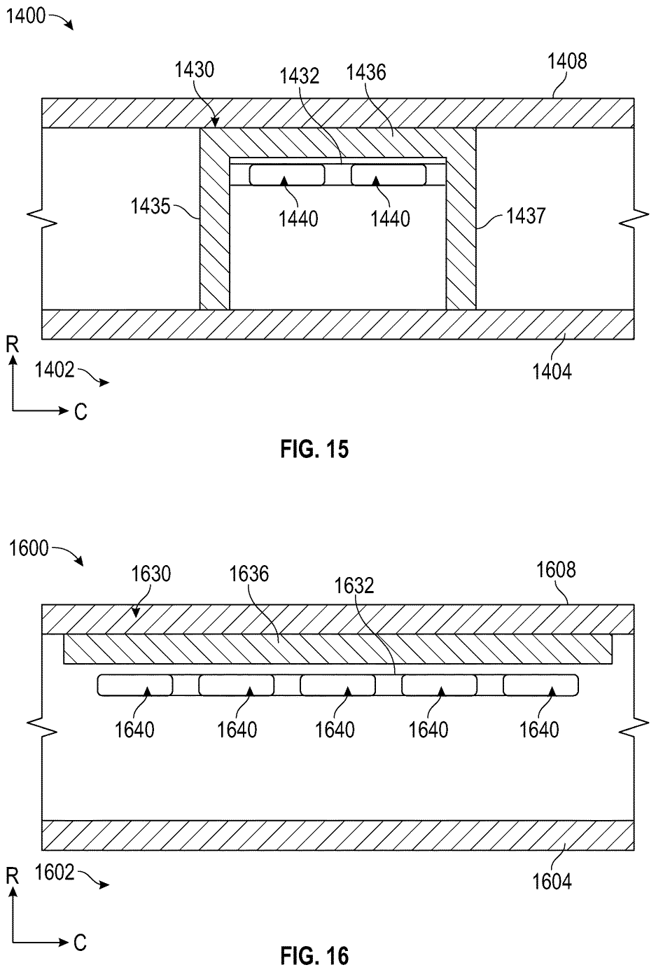

FIG. 15 is an enlarged schematic, cross-sectional view of the combustor 1400, taken at cross section 15-15 in FIG. 14, according to the present disclosure. FIG. 15 shows the one or more TVCs 1430 include discrete TVCs 1430 (only one shown in FIG. 15) that are spaced circumferentially about the combustion chamber 1402. Each TVC 1430 is defined by a first circumferential wall 1435 and a second circumferential wall 1437 spaced circumferentially from the first circumferential wall 1435. The first circumferential wall 1435 and the second circumferential wall 1437 extend axially from the forward wall 1432 to the aft wall 1434 (FIG. 14). In this way, the one or more TVCs 1430 include discrete TVCs in which combustion occurs between the forward wall 1432, the aft wall 1434, the first circumferential wall 1435, and the second circumferential wall 1437. As further shown in FIG. 15, the one or more first air holes 1440 include a plurality of forward slots spaced circumferentially about the TVC 1430. The one or more second air holes 1442 (FIG. 14) similarly include a plurality of aft slots spaced circumferentially about the TVC 1430.

FIG. 16 is an enlarged schematic, cross-sectional view of a trapped vortex cavity (TVC) 1630 for a combustor 1600 for a turbine engine, taken at a later centerline axis of the TBC 1630, according to another embodiment. FIG. 16 is a similar view as the view shown in FIG. 15. FIG. 16 shows a combustion chamber 1602, an outer liner 1604, an annular combustor casing 1608, the TVC 1630, a forward wall 1632 of the TBC 1630, an axial wall 1636 of the TVC 1630, and a plurality of first air holes 1640 through the forward wall 1632. The TVC 1630 is annular and extends circumferentially about the combustion chamber 1602. In this way, the TVC 1630 does not include circumferential walls. The plurality of second mixing assemblies (e.g., the plurality of second mixing assemblies 1420 of FIG. 14) are spaced circumferentially about the TVC 1630 and combustion occurs at discrete locations within the TVC 1630 at which the plurality of second mixing assemblies are disposed. The plurality of first air holes 1640 are forward slots that are spaced circumferentially about the TVC 1630. The TVC 1630 includes a plurality of second air holes (not shown in the view of FIG. 16) that are aft slots that are spaced circumferentially about the TVC 1630. The TVC 1630 can include a plurality of TVC openings (not shown in the view of FIG. 16) spaced circumferentially about the TVC 1630 such that the combustion gases are injected from the TVC 1630 into the combustion chamber 1602 through the plurality of TVC openings.

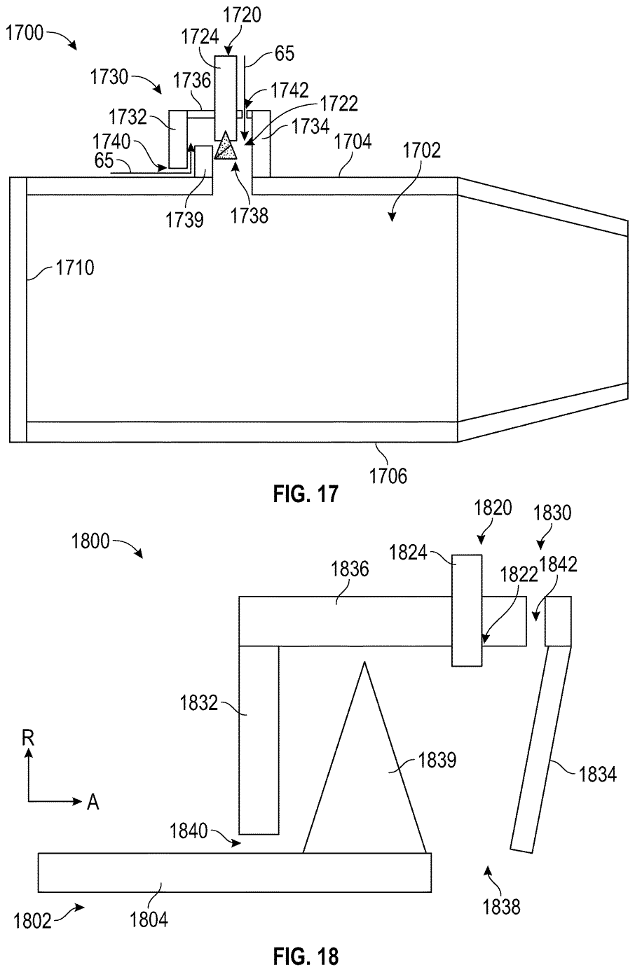

FIG. 17 is a schematic side view of a combustor 1700, according to another embodiment. The combustor 1700 is substantially similar to the combustor 200 of FIG. 2. The combustor 1700 includes a combustion chamber 1702, an outer liner 1704, an inner liner 1706, an annular combustor casing (not shown in the view of FIG. 17), an annular dome 1710, a plurality of first mixing assemblies (not showing in the view of FIG. 17 for clarity), a first fuel injector (not shown in the view of FIG. 17), a plurality of second mixing assemblies 1720 each having a second main mixer 1722 and a second fuel injector 1724, and a trapped vortex cavities (TVC) 1730. While one TVC 1730 is shown and described in FIG. 17, the combustor 1700 also can include a plurality of discrete TVCs 1730. The plurality of first mixing assemblies can be the plurality of first mixing assemblies 212 of FIG. 2 including a pilot mixer 214 (FIG. 2), a first main mixer 216 (FIG. 2), and a first fuel injector 218 (FIG. 2).

The TVC 1730 is substantially similar to the TVC 230 of FIG. 2. The TVC 1730 is defined by a forward wall 1732, an aft wall 1734, an axial wall 1736, and a TVC opening 1738. The TVC 1730 also includes one or more first air holes 1740 extending through the forward wall 1732 and one or more second air holes 1742 extending through the axial wall 1736. The one or more first air holes 1740 and the one or more second air holes 1742 operably direct the compressed air 65 therethrough and into the TVC 1730 to generate a first vortex and/or a second vortex, as detailed above with respect to FIG. 2. The one or more first air holes 1740 and the one or more second air holes 1742 each includes discrete slots spaced circumferentially about the TVC 1730. For example, the one or more first air holes 1740 are forward slots in the forward wall 1732 of the TVC 1730 and the one or more second air holes 1742 are aft slots in the aft wall 1734 of the TVC 1730. The one or more first air holes 1740 are formed between the forward wall 1732 and the outer liner 1704 and the one or more second air holes 1742 are formed through the axial wall 1736.

Each TVC 1730 includes one or more baffles 1739 disposed within the TVC 1730. The one or more baffles 1739 are substantially rectangular in cross section. The one or more baffles 1739 are spaced axially aft of the forward wall 1732 and extend radially outward from the outer liner 1704. A radial gap is formed between a radially inner surface of the axial wall 1736 and a radially outer surface of the one or more baffles 1739 such that the compressed air 65 can flow between the one or more baffles 1739 and the axial wall 1736 within the TVC 1730.

In operation, the one or more first air holes 1740 operably direct the compressed air 65 into the TVC 1730 through the one or more first air holes 1740. The compressed air 65 contacts the one or more baffles 1739, and the one or more baffles 1739 operably direct the compressed air 65 radially outward towards the inner surface of the axial wall 1736 and through the gap between the one or more baffles 1739 and the axial wall 1736. The compressed air 65 forms the first vortex and is mixed with fuel from the second fuel injector 1724, as detailed above. In this way, the one or more first air holes 1740 meter the flow of the compressed air 65 entering the TVC 1730 and the one or more baffles 1739 direct the compressed air 65 radially outward. The compressed air 65 that enters through the one or more first air holes 1740 mixes with compressed air 65 that enters through the one or more second air holes 1742. Accordingly, the one or more baffles 1739 allow for the flow rate of the compressed air 65 to be metered and controlled to achieve a desired equivalence ratio.

FIG. 18 is a schematic side view of a portion of a combustor 1800, according to another embodiment. FIG. 18 shows a portion of a combustion chamber 1802, a portion of an outer liner 1804, and a trapped vortex cavity (TVC) 1830. The combustor 1800 also includes a plurality of first mixing assemblies (e.g., the plurality of first mixing assemblies 212 of FIG. 2) and a plurality of second mixing assemblies 1820 having a second main mixer 1822 and a fuel injector 1824. The TVC 1830 is substantially similar to the TVCs 230, 1730 of FIGS. 2 and 17, respectively. The TVC 1830 is defined by a forward wall 1832, an aft wall 1834, an axial wall 1836, and a TVC opening 1838. The TVC 1830 also includes one or more first air holes 1840 extending through the forward wall 1832 and one or more second air holes 1842 extending through the axial wall 1836. The one or more first air holes 1840 and the one or more second air holes 1842 operably direct the compressed air 65 therethrough and into the TVC 1830 to generate a first vortex and/or a second vortex, as detailed above with respect to FIG. 2. The one or more first air holes 1840 and the one or more second air holes 1842 each includes discrete slots spaced circumferentially about the TVC 1830. For example, the one or more first air holes 1840 are forward slots in the forward wall 1832 of the TVC 1830 and the one or more second air holes 1842 are aft slots in the aft wall 1834 of the TVC 1830. The one or more first air holes 1840 are formed between the forward wall 1832 and the one or more second air holes 1842 are formed through the axial wall 1836.

Each TVC 1830 includes one or more baffles 1839 disposed within the TVC 1830. The one or more baffles 1839 are substantially triangular in cross section. The one or more baffles 1839 are spaced axially aft of the forward wall 1832 and extend radially outward from the outer liner 1804. A radial gap is formed between a radially inner surface of the axial wall 1836 and a radially outer surface of the one or more baffles 1839 such that the compressed air 65 can flow between the one or more baffles 1839 and the axial wall 1836 within the TVC 1830. The one or more baffles 1839 function substantially similarly to the one or more baffles 1739 of FIG. 17. The triangular cross section of the one or more baffles 1839, however, provides a diverging section at an inlet of the TVC 1830 (e.g., in an area between the forward wall 1832 and the one or more baffles 1839). The triangular cross section of the one or more baffles 1839 also provides a converging section at an outlet of the TVC 1830 (e.g., at the TVC opening 1838). The aft wall 1834 extends radially inward and axially forward from the axial wall 1836 such that the aft wall 1834 is angled with respect to the radial direction R. In this way, the one or more baffles 1839 and the aft wall 1834 provide a converging nozzle at the TVC opening 1838 to inject the combustion gases 66 from the TVC 1830 into the combustion chamber 1802. The diverging section and the converging section provided by the one or more baffles 1839 allow the flow rate of the compressed air 65 to decrease when entering the TVC 1830 and allow the flow rate of the combustion gases 66 to increase when exiting the TVC 1830 to achieve desired equivalence ratio at the TVC opening 1838.

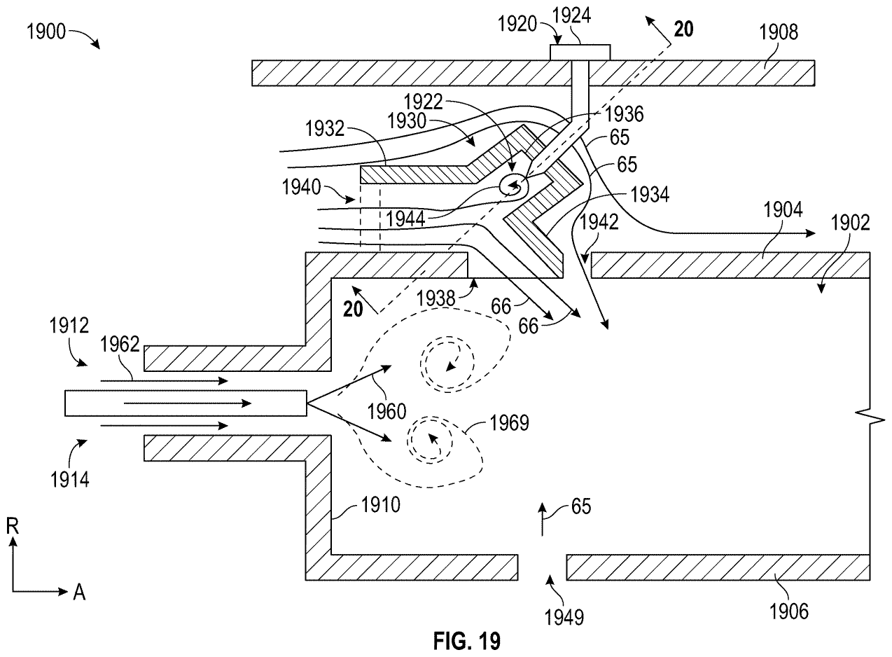

FIG. 19 is a partial, schematic, cross-sectional view of a combustor 1900 for a turbine engine, taken along a longitudinal centerline axis of the turbine engine, according to another embodiment. The combustor 1900 is substantially similar to the combustors 200, 1400 of FIGS. 2 and 14, respectively, and can be used in the turbine engine 10 (FIG. 1). The combustor 1900 includes a combustion chamber 1902, an outer liner 1904, an inner liner 1906, an annular combustor casing 1908, an annular dome 1910, a plurality of first mixing assemblies 1912 each having a pilot mixer 1914 and a first main mixer (not shown in the view of FIG. 19 for clarity), a first fuel injector (not shown in the view of FIG. 19 for clarity), a plurality of second mixing assemblies 1920 each having a second main mixer 1922 and a second fuel injector 1924, and one or more trapped vortex cavities (TVCs) 1930. A first portion 1962 of the compressed air 65 is provided to the pilot mixer 1914, and a pilot fuel stream 1960 of the fuel 67 is provided to the pilot mixer 1914 to generate a fuel-air mixture for combustion in the combustion chamber 1902. The pilot mixer 1914 swirls the first portion 1962 of compressed air 65 to generate a swirl air flow 1969 within the combustion chamber 1902. The first main mixer is substantially similar to the first main mixer 216 of FIG. 2.

The one or more TVCs 1930 are substantially similar to the TVC 230 of FIG. 2. The one or more TVCs 1930 are each defined by a forward wall 1932, an aft wall 1934, an axial wall 1936, and a TVC opening 1938. The one or more TVCs 1930 also includes one or more first air holes 1940 extending between the forward wall 1932 and the outer liner 1904, and one or more second air holes 1942 extending between the aft wall 1934 and the outer liner 1904. The one or more first air holes 1940 operably direct the compressed air 65 therethrough and into the TVC 1930 to generate a vortex 1944. The one or more second air holes 1942 operable direct the compressed air 65 therethrough into the combustion chamber 1902 to provide additional air into the combustion chamber 1902. The combustor 1900 includes one or more dilution holes 1949 extending through the inner liner 1906. The one or more dilution holes 1949 operably direct the compressed air 65 through the inner liner 1906 into the combustion chamber 1902 to provide additional air for combustion. In this way, the compressed air 65 is referred to as dilution air and assists in profile trimming.

The one or more TVCs 1930 are angled such that that one or more TVCs 1930 are angled with respect to the radial direction R and/or with respect to the axial direction A. In this way, the forward wall 1932, the aft wall 1934, and the axial wall 1936 are angled with respect to the radial direction R and the axial direction A. The one or more TVCs 1930 being angled in such a way allows a greater amount of compressed air 65 into the one or more TVCs 1930 and allows for a longer residence time of the fuel-air mixture in the one or more TVCs 1930. Thus, the angled one or more TVCs 1930 allow for controlling the combustion in the one or more TVCs 1930 to achieve a desired equivalence ratio and reduced NOₓ emissions during an entire operating cycle of the turbine engine 10 (FIG. 1). In particular, the angled one or more TVCs 1930 provide for flexibility in controlling the fuel-air mixing with an upstream fuel-air mixture from the plurality of first mixing assemblies 1912 that are positioned on the annular dome 1910.

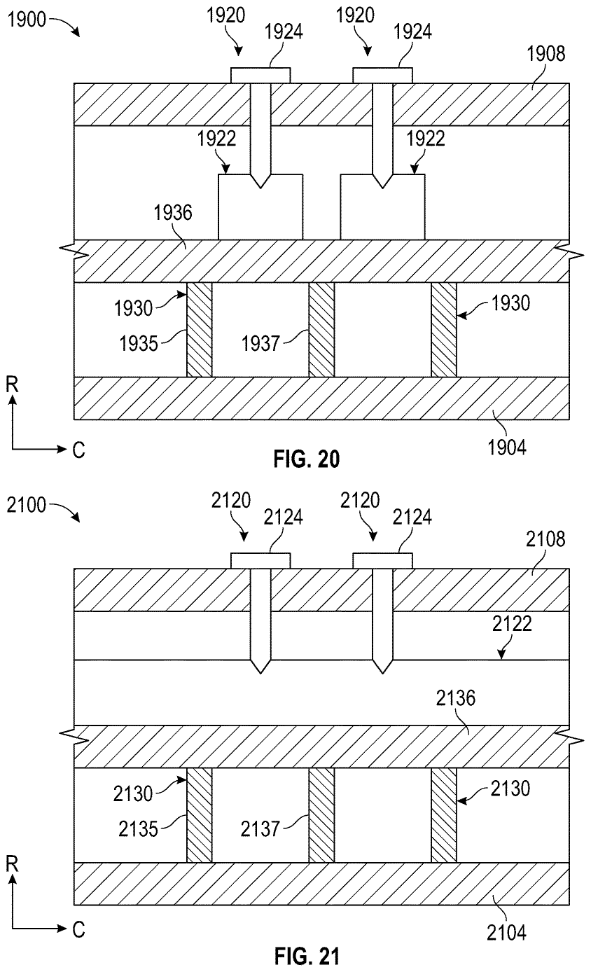

FIG. 20 is an enlarged, schematic cross-sectional view of the combustor 1900, taken at cross section 20-20 in FIG. 19, according to the present disclosure. FIG. 20 shows the one or more TVCs 1930 include discrete TVCs 1930 (only two shown in FIG. 20) that are spaced circumferentially about the combustion chamber 1902. Each TVC 1930 is defined by a first circumferential wall 1935 and a second circumferential wall 1937 spaced circumferentially from the first circumferential wall 1935. The one or more TVCs 1930 share a wall such that the second circumferential wall 1937 of one TVC 1930 is the first circumferential wall 1935 of another TVC 1930. The first circumferential wall 1935 and the second circumferential wall 1937 extend axially from the forward wall 1932 (FIG. 19) to the aft wall 1934 (FIG. 19). In this way, the one or more TVCs 1930 include discrete TVCs in which combustion occurs between the forward wall 1932, the aft wall 1934, the first circumferential wall 1935, and the second circumferential wall 1937. As further shown in FIG. 20, the second main mixer 1922 of each second mixing assembly 1920 is a discrete second main mixer 1922.

FIG. 21 is an enlarged schematic, cross-sectional view of a trapped vortex cavity (TVC) 2130 for a combustor 2100 for a turbine engine, taken at a lateral centerline axis of the TVC 2130, according to another embodiment. FIG. 21 is a similar view as the view shown in FIG. 20. FIG. 21 shows an outer liner 2104, an annular combustor casing 2108, one or more TVCs 2130, an axial wall 2136 of the one or more TVCs 2130, a first circumferential wall 2135, a second circumferential wall 2137, a plurality of second mixing assemblies 1220 each having a second fuel injector 2124. The plurality of second mixing assemblies 2120 include a second main mixer 2122. The second main mixer 2122 is annular about the circumferential direction C such that there is a single second main mixer 2122. The second fuel injector 2124 of each of the plurality of second mixing assemblies 2120 is in flow communication with the second main mixer 2122 and is spaced circumferentially about the second main mixer 2122. For example, each second fuel injector 2124 is circumferentially aligned with a respective TVC 2130 to provide the fuel-air mixture into the respective TVC 2130. The annular second main mixer 2122 provides for easier ignition than the discrete second main mixers 1922 of FIG. 20.

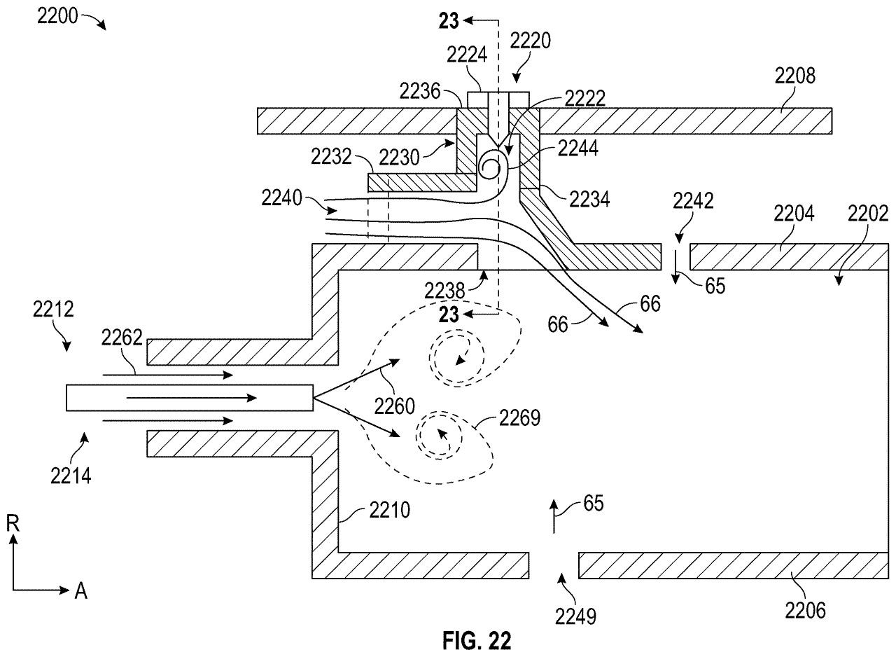

FIG. 22 is a partial, schematic, cross-sectional view of a combustor 2200 for a turbine engine, taken along a longitudinal centerline axis of the turbine engine, according to another embodiment. The combustor 2200 is substantially similar to the combustors 200, 1400, 1900 of FIGS. 2, 14, and 19, respectively, and can be used in the turbine engine 10 (FIG. 1). The combustor 2200 includes a combustion chamber 2202, an outer liner 2204, an inner liner 2206, an annular combustor casing 2208, an annular dome 2210, a plurality of first mixing assemblies 2212 each having a pilot mixer 2214 and a first main mixer (not shown in the view of FIG. 22 for clarity), a first fuel injector (not shown in the view of FIG. 22 for clarity), a plurality of second mixing assemblies 2220 each having a second main mixer 2222 and a second fuel injector 2224, and one or more trapped vortex cavities (TVCs) 2230. A first portion 2262 of the compressed air 65 is provided to the pilot mixer 2214, and a pilot fuel stream 2260 of the fuel 67 is provided to the pilot mixer 2214 to generate a fuel-air mixture for combustion in the combustion chamber 2202. The pilot mixer 2214 swirls the first portion 2262 of compressed air 65 to generate a swirl air flow 2269 within the combustion chamber 2202. The first main mixer is substantially similar to the first main mixer 216 of FIG. 2.

The one or more TVCs 2230 are substantially similar to the TVC 230 of FIG. 2. The one or more TVCs 2230 are each defined by a forward wall 2232, an aft wall 2234, an axial wall 2236, and a TVC opening 2238. The one or more TVCs 2230 also includes one or more first air holes 2240 extending between the forward wall 2232 and the outer liner 2204, and one or more second air holes 2242 extending between the aft wall 2234 and the outer liner 2204. The one or more first air holes 2240 operably direct the compressed air 65 therethrough and into the TVC 2230 to generate a vortex 2244. The one or more second air holes 2242 operable direct the compressed air 65 therethrough into the combustion chamber 2202 to provide additional air into the combustion chamber 2202. The combustor 2200 includes one or more dilution holes 2249 extending through the inner liner 2206. The one or more dilution holes 2249 operably direct the compressed air 65 through the inner liner 2206 into the combustion chamber 2202 to provide additional air for combustion. In this way, the compressed air 65 is referred to as dilution air and assists in profile trimming.

The one or more TVCs 2230 extend from the outer liner 2204 to the annular combustor casing 2208. In this way, the axial wall 2236 of the one or more TVCs 2230 contacts the annular combustor casing 2208. For example, the second main mixer 2222 forms a portion of the one or more TVCs 2230 and contacts the annular combustor casing 2208. A portion of the aft wall 2234 is angled with respect to the radial direction R and the axial direction A.

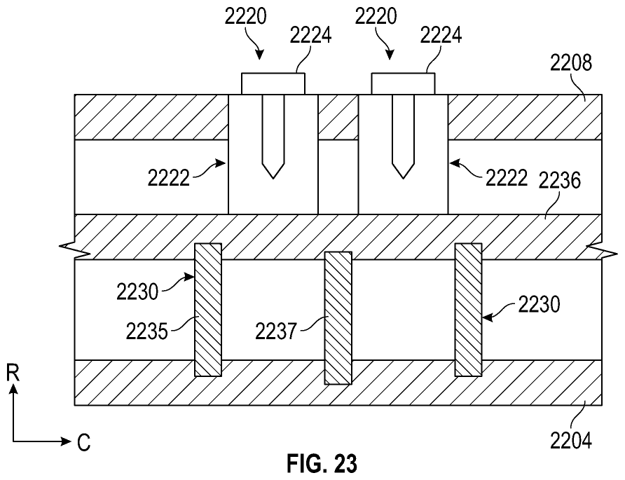

FIG. 23 is an enlarged, schematic cross-sectional view of the combustor 2200, taken at cross section 23-23 in FIG. 22, according to the present disclosure. FIG. 23 shows the one or more TVCs 2230 include discrete TVCs 2230 (only two shown in FIG. 23) that are spaced circumferentially about the combustion chamber 2202. Each TVC 2230 is defined by a first circumferential wall 2235 and a second circumferential wall 2237 spaced circumferentially from the first circumferential wall 2235. The one or more TVCs 2230 share a wall such that the second circumferential wall 2237 of one TVC 2230 is the first circumferential wall 2235 of another TVC 2230. The first circumferential wall 2235 and the second circumferential wall 2237 extend axially from the forward wall 2232 (FIG. 22) to the aft wall 2234 (FIG. 22). In this way, the one or more TVCs 2230 include discrete TVCs in which combustion occurs between the forward wall 2232, the aft wall 2234, the first circumferential wall 2235, and the second circumferential wall 2237. As further shown in FIG. 23, the second main mixer 2222 of each second mixing assembly 2220 is a discrete second main mixer 2222, and contacts the annular combustor casing 2208.

The embodiments detailed herein provide for a multi-staged combustor including radial staging and axial staging combined with one or more TVCs that inject combustion gases downstream of a primary combustion zone, thereby, providing for improved stoichiometric capabilities in the combustor, while reducing NOₓ emissions, across the entire mission operating cycle of a turbine engine. The radial staging and axial-staged TVC together provide for greater NOₓ reductions, while allowing for leaner fuel-air ratios to the pilot mixer and the first main mixer or the second main mixer, as compared to combustors without the benefit of the present disclosure. Further, hybrid staging (e.g., radial staging and axial staging) in such a way allows for a uniform and leaner fuel-air mixture so that NOₓ emissions are reduced even at much higher fuel-air ratios for highly efficient engine cycles as compared to combustors that utilize only radial staging or combustors that utilize only axial staging.

Further aspects of the present disclosure are provided by the subject matter of the following clauses.

A turbine engine comprises a combustor comprising a combustion chamber including an outer liner and an inner liner, the combustion chamber defining a radial direction, an axial direction, and a circumferential direction, an annular dome coupled to the outer liner and the inner liner at a forward end of the combustion chamber, and a trapped vortex cavity (TVC) formed in at least one of the outer liner or the inner liner and downstream of the annular dome; a plurality of first mixing assemblies each having a pilot mixer and a first main mixer, the plurality of first mixing assemblies disposed through the annular dome, the pilot mixer operably injecting a pilot mixer fuel-air mixture axially into a first combustion zone of the combustion chamber, and the first main mixer operably injecting a first main mixer fuel-air mixture radially into the first combustion zone, and a plurality of second mixing assemblies each having a second main mixer, the plurality of second mixing assemblies disposed through the outer liner or the inner liner at the TVC and axially aft of the plurality of first mixing assemblies, the second main mixer operably injecting a second main mixer fuel-air mixture radially into a second combustion zone of the combustion chamber that is defined by the TVC to produce combustion gases, the second combustion zone being axially aft of, and separate from, the first combustion zone, and the TVC operably injecting the combustion gases into the combustion chamber.

The turbine engine of the preceding clause, the TVC being a circumferentially continuous cavity that is annular about the combustion chamber.

The turbine engine of any preceding clause, the TVC including a plurality of TVCs that are spaced circumferentially about the combustion chamber.

The turbine engine of any preceding clause, the combustion chamber including a length L in the axial direction measured from the annular dome to a combustion chamber outlet, the second main mixer being disposed on the outer liner or the inner liner at an axial length L_{A} measured from the annular dome to a longitudinal centerline axis of the second main mixer, and a ratio (L/L_{A}) of the length L of the combustion chamber to the axial length L_{A} of the second main mixer is in a range from 0.2 to 0.8.

The turbine engine of any preceding clause, the second main mixer being disposed at a first angle θ with respect to the radial direction, the first angle θ being in a range from −60° to 60°.

The turbine engine of any preceding clause, the second main mixer being disposed at a second angle φ with respect to the circumferential direction, the second angle φ being in a range from −80° to 80°.

The turbine engine of any preceding clause, the TVC being defined by a forward wall, an aft wall, and an axial wall that extends from the forward wall to aft wall, the forward wall and the aft wall extending generally radially outward from the outer liner or the inner liner.

The turbine engine of any preceding clause, the plurality of second mixing assemblies extending through the axial wall of the TVC.

The turbine engine of any preceding clause, further comprising a fuel system that operably provides fuel splits to the pilot mixer, the first main mixer, and the second main mixer such that the pilot mixer is fuel-rich, the first main mixer is fuel-lean, and the second main mixer is more fuel-lean than the first main mixer.

The turbine engine of any preceding clause, the fuel system operably providing the fuel to the pilot mixer, the first main mixer, and the second main mixer such that the pilot mixer or the pilot mixer and the first main mixer operate at low power operation of the turbine engine, and the pilot mixer, the first main mixer, and the second main mixer operate at mid-level power operation or high power operation of the turbine engine.

The turbine engine of any preceding clause, further including one or more air holes that operably direct compressed air into the TVC to generate one or more vortices within the TVC.

The turbine engine of any preceding clause, the one or more air holes including one or more first air holes that generate a first vortex in the TVC.

The turbine engine of any preceding clause, the one or more second air holes including one or more second air holes that generate a second vortex in the TVC.

The turbine engine of any preceding clause, the first vortex and the second vortex being counter-rotating.

The turbine engine of any preceding clause, the second vortex being radially inward of the first vortex.

The turbine engine of any preceding clause, the pilot mixer fuel-air mixture and/or the first main mixer fuel-air mixture being ignited to generate a first flame within the first combustion zone.

The turbine engine of any preceding clause, the second main mixer fuel-air mixture being ignited to generate a second main flame within the second combustion zone of the TVC.

The turbine engine of any preceding clause, the one or more vortices trapping the second flame within the TVC.

The turbine engine of any preceding clause, the one or more vortices including a single vortex.

The turbine engine of any preceding clause, the first flame producing combustion gases within the first combustion zone.

The turbine engine of any preceding clause, the combustion chamber operably directing the combustion gases from the first combustion zone downstream to mix with the combustion gases from the TVC within the combustion chamber.

The turbine engine of any preceding clause, the combustion chamber extending from the annular dome to a combustion chamber outlet.

The turbine engine of any preceding clause, the plurality of first mixing assemblies being spaced circumferentially about the annular dome.

The turbine engine of any preceding clause, each first mixing assembly being a twin annular premixing swirler (TAPS).

The turbine engine of any preceding clause, further comprising a plurality of first fuel injectors each coupled in flow communication with a respective first mixing assembly.

The turbine engine of any preceding clause, the plurality of second mixing assemblies being spaced circumferentially about the outer liner or the inner liner.

The turbine engine of any preceding clause, further comprising a plurality of second fuel injectors each coupled in flow communication with a respective second mixing assembly.

The turbine engine of any preceding clause, low power operation being less than 30% of sea level static (SLS) maximum engine rated thrust.

The turbine engine of any preceding clause, mid-level power operation being from 30% to 85% of the SLS maximum engine rated thrust.

The turbine engine of any preceding clause, high power operation being greater than 85% of the SLS maximum engine rated thrust.

The turbine engine of any preceding clause, the first main mixer swirling the first main mixer fuel-air mixture in a first swirl direction.

The turbine engine of any preceding clause, the second main mixer swirling the second main mixer fuel-air mixture in a second swirl direction.

The turbine engine of any preceding clause, the second swirl direction being the same as the first swirl direction.

The turbine engine of any preceding clause, the second swirl direction being different from the first swirl direction.

The turbine engine of any preceding clause, the combustor operably directing a first portion of compressed air to the pilot mixer, a second portion of compressed air to the first main mixer, and a third portion of compressed air to the second main mixer.

The turbine engine of any preceding clause, the first portion of compressed air including 7% to 20% of the compressed air provided to the pilot mixer, the second portion of compressed air including 30% to 60% of the compressed air provided to the pilot mixer, and the third portion of compressed air including 11% to 30% of the compressed air provided to the second main mixer.

The turbine engine of any preceding clause, the first portion of compressed air including 12% to 20% of the compressed air provided to the pilot mixer, and the third portion of compressed air including 15% to 30% of the compressed air provided to the second main mixer.

The turbine engine of any preceding clause, the first portion of compressed air including 12% to 20% of the compressed air provided to the pilot mixer, and the third portion of compressed air including 45% to 65% of the compressed air provided to the second main mixer.

The turbine engine of any preceding clause, the pilot mixer generating a pilot fuel stream such that the pilot fuel-air mixture is fuel-rich, the first main mixer generating a first main fuel stream such that the first main mixer fuel-air mixture is fuel-lean, and the second main mixer generating a second main fuel stream such that the second main mixer fuel-air mixture is more fuel-lean than the first main mixer fuel-air mixture.

The turbine engine of any preceding clause, the pilot fuel stream including 90% to 100% of the fuel during idle conditions of the turbine engine, 35% to 50% of the fuel during approach conditions of the turbine engine, 20% to 40% of the fuel during cruise conditions of the turbine engine, and 5% to 20% of the fuel during climb conditions or take-off conditions of the turbine engine.

The turbine engine of any preceding clause, the first main fuel stream including 0% to 5% of the fuel during idle conditions of the turbine engine, 50% to 58% of the fuel during approach conditions of the turbine engine, 55% to 70% of the fuel during cruise conditions of the turbine engine, and 65% to 72% of the fuel during climb conditions or take-off conditions of the turbine engine.

The turbine engine of any preceding clause, the second main fuel stream including 0% to 5% of the fuel during idle conditions of the turbine engine, 0% to 7% of the fuel during approach conditions of the turbine engine, 5% to 10% of the fuel during cruise conditions of the turbine engine, and 15% to 23% of the fuel during climb conditions or take-off conditions of the turbine engine.

The turbine engine of any preceding clause, the pilot mixer generating a pilot fuel stream such that the pilot fuel-air mixture is fuel-rich, and the second main mixer generating a second main fuel stream such that the second main mixer fuel-air mixture is fuel-lean.

The turbine engine of any preceding clause, the pilot fuel stream including 95% to 100% of the fuel during idle conditions, approach conditions, and cruise conditions of the turbine engine, and 65% to 80% of the fuel during climb conditions and take-off conditions of the turbine engine.

The turbine engine of any preceding clause, the second main fuel stream including 0% to 5% of the fuel during idle conditions, approach conditions, and cruise conditions of the turbine engine, and 20% to 35% of the fuel during climb conditions and take-off conditions.

The turbine engine of any preceding clause, the pilot fuel stream including 80% to 100% of the fuel during idle conditions, 40% to 100% of the fuel during approach conditions, and 15% to 50% of the fuel during cruise conditions, climb conditions, and take-off conditions.

The turbine engine of any preceding clause, the second main fuel stream including 0% to 20% of the fuel during idle conditions, 0% to 60% of the fuel during approach conditions, and 50% to 85% cruise conditions, climb conditions, and take-off conditions.

The turbine engine of any preceding clause, the combustor operably directing the compressed air through the annular dome, through the outer liner and the inner liner in an area forward of the plurality of second mixing assemblies, and through the outer liner and the inner liner in an area aft of the plurality of second mixing assemblies.

The turbine engine of any preceding clause, the combustor operably directing 5% to 9% of the compressed air to the annular dome, 7% to 10% of the compressed air to the outer liner and the inner liner in the area forward of the plurality of second mixing assemblies, and 6% to 9% of the compressed air to the outer liner and the inner liner in an area aft of the plurality of second mixing assemblies.

The turbine engine of any preceding clause, the combustor operably directing 5% to 9% of the compressed air to the annular dome, 35% to 50% of the compressed air to one or more dilution holes on the outer liner or the inner liner, 7% to 10% of the compressed air to the outer liner and the inner liner in the area forward of the plurality of second mixing assemblies, and 6% to 9% of the compressed air to the outer liner and the inner liner in an area aft of the plurality of second mixing assemblies.

The turbine engine of any preceding clause, the combustor operably directing 5% to 9% of the compressed air to the annular dome, 5% to 15% of the compressed air to one or more dilution holes on the outer liner or the inner liner, 7% to 9% of the compressed air to the outer liner and the inner liner in the area forward of the plurality of second mixing assemblies, and 7% to 9% of the compressed air to the outer liner and the inner liner in an area aft of the plurality of second mixing assemblies.

The turbine engine of any preceding clause, the annular dome including one or more cooling holes to provide the compressed air through the annular dome into the combustion chamber.

The turbine engine of any preceding clause, the outer liner including one or more cooling holes to provide the compressed air through the outer liner into the combustion chamber.

The turbine engine of any preceding clause, the inner liner including one or more cooling holes to provide the compressed air through the outer liner into the combustion chamber.

The turbine engine of any preceding clause, the TVC including one or more cooling holes extending through the axial wall.

The turbine engine of any preceding clause, the one or more cooling holes being angled with respect to the axial direction.

The turbine engine of any preceding clause, the plurality of first mixing assemblies and the plurality of second mixing assemblies being circumferentially aligned about the circumferential direction.

The turbine engine of any preceding clause, the plurality of first mixing assemblies and the plurality of second mixing assemblies being circumferentially misaligned about the circumferential direction.

The turbine engine of any preceding clause, the plurality of second mixing assemblies including a first plurality of mixing assemblies on the outer liner and a second plurality of second mixing assemblies on the inner liner.

The turbine engine of any preceding clause, the plurality of first mixing assemblies, the first plurality of second mixing assemblies, and the second plurality of second mixing assemblies being circumferentially aligned about the circumferential direction.

The turbine engine of any preceding clause, the plurality of first mixing assemblies and the second plurality of second mixing assemblies being circumferentially aligned about the circumferential direction, and the first plurality of second mixing assemblies being circumferentially misaligned about the circumferential direction with the plurality of first mixing assemblies and the second plurality of second mixing assemblies.

The turbine engine of any preceding clause, the plurality of first mixing assemblies and the first plurality of second mixing assemblies being circumferentially aligned about the circumferential direction, and the second plurality of second mixing assemblies being circumferentially misaligned about the circumferential direction with the plurality of first mixing assemblies and the first plurality of second mixing assemblies.

The turbine engine of any preceding clause, the plurality of second mixing assemblies being located at an axial center of the axial wall.

The turbine engine of any preceding clause, the plurality of second mixing assemblies being located at an axial forward end of the axial wall.

The turbine engine of any preceding clause, the plurality of second mixing assemblies being located an axial aft end of the axial wall.

The turbine engine of any preceding clause, the plurality of second mixing assemblies extending radially to inject the second main mixer fuel-air mixture radially into the TVC.

The turbine engine of any preceding clause, the plurality of second mixing assemblies extending at an angle to inject the second main mixer fuel-air mixture axially aft and radially inward into the TVC.

The turbine engine of any preceding clause, the plurality of second mixing assemblies extending at an angle to inject the second main mixer fuel-air mixture axially forward and radially inward into the TVC.

The turbine engine of any preceding clause, further including one or more air slots in fluid communication with the TVC, the one or more air slots operably directing compressed air therethrough to generate an air chute at the TVC opening.

The turbine engine of any preceding clause, the one or more air slots formed by the forward wall being radially separated from the outer liner to define the one or more air slots.

The turbine engine of any preceding clause, the one or more air slots formed by the aft wall being radially separated from the outer liner to define the one or more air slots.

The turbine engine of any preceding clause, the outer liner extending into the TVC such that outer liner and the forward wall define the TVC opening such that the TVC opening functions as a nozzle.

The turbine engine of any preceding clause, further comprising one or more dilution holes in the outer liner or the inner liner.

The turbine engine of any preceding clause, the one or more air holes include one or more first air holes in the forward wall, and one or more second air holes in the aft wall.

The turbine engine of any preceding clause, the one or more first air holes defining one or more forward slots, and the one or more second holes defining one or more aft slots.

The turbine engine of any preceding clause, the TVC including a plurality of TVCs, each TVC being defined by a first circumferential wall and a second circumferential wall defined between adjacent TVCs.

The turbine engine of any preceding clause, the TVC being substantially annular about the combustion chamber.

The turbine engine of any preceding clause, the TVC including one or more baffles disposed within the TVC.

The turbine engine of any preceding clause, the one or more baffles spaced axially aft of the forward wall and extending radially outward from the outer liner.

The turbine engine of any preceding clause, further comprising a radial gap between the axial wall and the one or more baffles such that the compressed air flows between the one or more baffles and the axial wall within the TVC.

The turbine engine of any preceding clause, the one or more baffles being substantially rectangular in cross section.

The turbine engine of any preceding clause, the one or more baffles being substantially triangular in cross section.

The turbine engine of any preceding clause, the one or more baffles defining a diverging section at a forward end of the TVC and a converging section at an aft end of the TVC.

The turbine engine of any preceding clause, the aft wall being angled towards the one or more baffles to define the converging section.

The turbine engine of any preceding clause, the TVC being angled with respect to the axial direction and the radial direction.

The turbine engine of any preceding clause, the second main mixer of each of the plurality of second mixing assemblies being a discrete second main mixer.

The turbine engine of any preceding clause, the second main mixer of each of the plurality of second mixing assemblies being a singular second main mixer, the singular second main mixer being annular about the combustion chamber.

The turbine engine of any preceding clause, the TVC being radially spaced from the annular combustor casing.

The turbine engine of any preceding clause, the axial wall of the TVC contacting the annular combustor casing.

A combustor for a turbine engine, the turbine engine being the turbine engine of any preceding clause.

A method of operating the turbine engine of any preceding clause, the method comprising generating the pilot mixer fuel-air mixture with the pilot mixer, injecting the pilot mixer fuel-air mixture axially into the first combustion zone of the combustion chamber to generate a pilot flame, generating the first main mixer fuel-air mixture with the first main mixer, injecting the first main mixer fuel-air mixture radially from the first main mixer and into the first combustion zone of the combustion chamber to generate a first main flame, the pilot flame and the first main flame generating combustion gases in the first combustion zone, generating the second main mixer fuel-air mixture with the second main mixer, injecting the second main mixer fuel-air mixture radially into the second combustion zone of the TVC to generate a second main flame that produces combustion gases within the TVC, and injecting the combustion gases from the TVC into the combustion chamber downstream of the first combustion zone.

The method of the preceding clause, further comprising operably directing the combustion gases in the first combustion zone downstream from the first combustion zone, and mixing the combustion gases from the first combustion zone with the combustion gases from the TVC in the combustion chamber.

The method of any preceding clause, further comprising operably directing a first portion of compressed air to the pilot mixer, a second portion of compressed air to the first main mixer, and a third portion of compressed air to the second main mixer.

The method of any preceding clause, further comprising generating a pilot fuel stream with the pilot mixer such that the pilot mixer fuel-air mixture is fuel-rich, generating a first main fuel stream with the first main mixer such that the first main mixer fuel-air mixture is fuel-lean, and generating a second main fuel stream with the second main mixer such that the second main mixer fuel-air mixture is more fuel-lean than the first main mixer fuel-air mixture.

The method of any preceding clause, further comprising generating a pilot fuel stream with the pilot mixer such that the pilot mixer fuel-air mixture is fuel-rich, and generating a main fuel stream with the second main mixer such that the second main mixer fuel-air mixture is fuel-lean.

The method of any preceding clause, further comprising generating one or more vortices within the TVC such that the second main flame is trapped within the TVC.

The method of any preceding clause, the one or more vortices including dual vortices.

The method of any preceding clause, the one or more vortices including a single vortex.

The method of any preceding clause, further comprising operating the pilot mixer, the first main mixer, and the second main mixer during a mid-level power operation or a high power operation of the turbine engine.

The method of any preceding clause, further comprising operating the pilot mixer during a low power operation of the turbine engine.

The method of any preceding clause, further comprising operating the pilot mixer and the first main mixer during a low power operation.

The method of any preceding clause, the turbine engine being the turbine engine of any preceding clause.

Although the foregoing description is directed to the preferred embodiments of the present disclosure, other variations and modifications will be apparent to those skilled in the art and may be made without departing from the spirit or the scope of the disclosure. Moreover, features described in connection with one embodiment of the present disclosure may be used in conjunction with other embodiments, even if not explicitly stated above.

1. A method of operating a turbine engine, the method comprising:
generating a pilot mixer fuel-air mixture with a pilot mixer of a first mixing assembly of the turbine engine, the first mixing assembly disposed through an annular dome of a combustor of the turbine engine;
injecting the pilot mixer fuel-air mixture axially into a first combustion zone of a combustion chamber of the combustor to generate a pilot flame;
generating a first main mixer fuel-air mixture with a first main mixer of the first mixing assembly;
injecting the first main mixer fuel-air mixture radially from the first main mixer and into the first combustion zone of the combustion chamber to generate a first main flame, the pilot flame and the first main flame generating combustion gases in the first combustion zone;
generating a second main mixer fuel-air mixture with a second main mixer of a second mixing assembly of the turbine engine, the second mixing assembly disposed through a trapped vortex cavity (TVC) on an outer liner or an inner liner of the combustor and axially aft of the first mixing assembly;
injecting the second main mixer fuel-air mixture radially into a second combustion zone of the TVC to generate a second main flame that produces combustion gases within the TVC; and
injecting the combustion gases from the TVC into the combustion chamber downstream of the first combustion zone.

2. The method of claim 1, further comprising operably directing the combustion gases in the first combustion zone downstream from the first combustion zone, and mixing the combustion gases from the first combustion zone with the combustion gases from the TVC in the combustion chamber.

3. The method of claim 1, further comprising operably directing a first portion of compressed air to the pilot mixer, a second portion of compressed air to the first main mixer, and a third portion of compressed air to the second main mixer.

4. The method of claim 1, further comprising generating a pilot fuel stream with the pilot mixer such that the pilot mixer fuel-air mixture is fuel-rich, generating a first main fuel stream with the first main mixer such that the first main mixer fuel-air mixture is fuel-lean, and generating a second main fuel stream with the second main mixer such that the second main mixer fuel-air mixture is more fuel-lean than the first main mixer fuel-air mixture.

5. The method of claim 1, further comprising generating a pilot fuel stream with the pilot mixer such that the pilot mixer fuel-air mixture is fuel-rich, and generating a main fuel stream with the second main mixer such that the second main mixer fuel-air mixture is fuel-lean.

6. The method of claim 1, further comprising generating one or more vortices within the TVC such that the second main flame is trapped within the TVC.

7. The method of claim 6, wherein the one or more vortices include dual vortices.

8. The method of claim 1, further comprising operating the pilot mixer, the first main mixer, and the second main mixer during a mid-level power operation or a high power operation of the turbine engine.

9. The method of claim 8, further comprising operating the pilot mixer during a low power operation of the turbine engine.

10. The method of claim 8, further comprising operating the pilot mixer and the first main mixer during a low power operation.

11. The method of claim 1, further comprising operably directing a first portion of compressed air to the pilot mixer, a second portion of compressed air to the first main mixer, and a third portion of compressed air to the second main mixer, the first portion of compressed air including 7% to 20% of the compressed air provided to the pilot mixer, the second portion of compressed air including 30% to 60% of the compressed air provided to the pilot mixer, and the third portion of compressed air including 11% to 30% of the compressed air provided to the second main mixer.

12. The method of claim 11, wherein the first portion of compressed air includes 12% to 20% of the compressed air provided to the pilot mixer, and the third portion of compressed air includes 15% to 30% of the compressed air provided to the second main mixer.

13. The method of claim 11, wherein the first portion of compressed air includes 12% to 20% of the compressed air provided to the pilot mixer, and the third portion of compressed air includes 45% to 65% of the compressed air provided to the second main mixer.

14. The method of claim 11, further comprising operably directing 5% to 9% of the compressed air to the annular dome, 7% to 10% of the compressed air to the outer liner and the inner liner in an area forward of the second mixing assembly, and 6% to 9% of the compressed air to the outer liner and the inner liner in an area aft of the second mixing assembly.

15. The method of claim 11, further comprising operably directing 5% to 9% of the compressed air to the annular dome, 35% to 50% of the compressed air to one or more dilution holes on the outer liner or the inner liner, 7% to 10% of the compressed air to the outer liner and the inner liner in an area forward of the second mixing assembly, and 6% to 9% of the compressed air to the outer liner and the inner liner in an area aft of the second mixing assembly.

16. The method of claim 11, further comprising operably directing 5% to 9% of the compressed air to the annular dome, 5% to 15% of the compressed air to one or more dilution holes on the outer liner or the inner liner, 7% to 9% of the compressed air to the outer liner and the inner liner in an area forward of the second mixing assembly, and 7% to 9% of the compressed air to the outer liner and the inner liner in an area aft of the second mixing assembly.

17. The method of claim 1, further comprising generating a pilot fuel stream with the pilot mixer for the pilot mixer fuel-air mixture, generating a first main fuel stream with the first main mixer for the first main mixer fuel-air mixture, and generating a second main fuel stream with the second main mixer for the second main mixer fuel-air mixture.

18. The method of claim 17, further comprising:
generating the pilot fuel stream with the pilot mixer such that the pilot fuel stream includes 90% to 100% of the fuel during idle conditions of the turbine engine, 35% to 50% of the fuel during approach conditions of the turbine engine, 20% to 40% of the fuel during cruise conditions of the turbine engine, and 5% to 20% of the fuel during climb conditions or take-off conditions of the turbine engine;
generating the first main fuel stream with the first main mixer such that the first main fuel stream includes 0% to 5% of the fuel during idle conditions of the turbine engine, 50% to 58% of the fuel during approach conditions of the turbine engine, 55% to 70% of the fuel during cruise conditions of the turbine engine, and 65% to 72% of the fuel during climb conditions or take-off conditions of the turbine engine; and
generating the second main fuel stream with the second main mixer such that the second main fuel stream includes 0% to 5% of the fuel during idle conditions of the turbine engine, 0% to 7% of the fuel during approach conditions of the turbine engine, 5% to 10% of the fuel during cruise conditions of the turbine engine, and 15% to 23% of the fuel during climb conditions or take-off conditions of the turbine engine.

19. The method of claim 17, further comprising:
generating the pilot fuel stream with the pilot mixer such that the pilot fuel stream includes 95% to 100% of the fuel during idle conditions, approach conditions, and cruise conditions of the turbine engine, and 65% to 80% of the fuel during climb conditions and take-off conditions of the turbine engine; and
generating the second main fuel stream with the second main mixer such that the second main fuel stream includes 0% to 5% of the fuel during idle conditions, approach conditions, and cruise conditions of the turbine engine, and 20% to 35% of the fuel during climb conditions and take-off conditions.

20. The method of claim 17, further comprising:
generating the pilot fuel stream with the pilot mixer such that the pilot fuel stream including 80% to 100% of the fuel during idle conditions, 40% to 100% of the fuel during approach conditions, and 15% to 50% of the fuel during cruise conditions, climb conditions, and take-off conditions; and
generating the second main fuel stream with the second main mixer such that the second main fuel stream includes 0% to 20% of the fuel during idle conditions, 0% to 60% of the fuel during approach conditions, and 50% to 85% cruise conditions, climb conditions, and take-off conditions.
